(19) United States
(12) Patent Application Publication
(10) Pub. No.: US 2026/0202827 A1
(43) Pub. Date: Jul. 16, 2026

(54) ABNORMALITY DETECTING METHOD, COMPUTING DEVICE, PROGRAM, CORRECTING METHOD, ABNORMALITY DEGREE GENERATING DEVICE, MACHINE LEARNING DEVICE, ELECTRONIC APPARATUS, SIMULATION DEVICE, DATA PROCESSING METHOD, AND SIMULATION PROGRAM

(71) Applicant: ROHM Co., Ltd., Kyoto (JP)

(72) Inventors: Kenji HAMACHI, Kyoto (JP); Hiroki Ishibashi, Kyoto (JP); Koji Tamano, Kyoto (JP); Yuji Kurotsuchi, Kyoto (JP); Takahiro Nishiyama, Kyoto (JP)

(21) Appl. No.: 19/447,962

(22) Filed: Jan. 13, 2026

(30) Foreign Application Priority Data
Jan. 16, 2025 (JP) 2025-6189
Jan. 17, 2025 (JP) 2025-6752
Jan. 30, 2025 (JP) 2025-13776
Nov. 21, 2025 (JP) 2025-201828

(51) Int. Cl. G05B 19/418; G06N 3/088

(52) U.S. Cl. CPC G05B 19/4184; G05B 19/41885; G06N 3/088

(57) ABSTRACT

Provided is an abnormality detecting method using a computing device, one cluster of data in a case where data is sequentially supplied to a machine learning model being referred to as a chunk. The abnormality detecting method includes obtaining a learning result by performing unsupervised learning by the machine learning model with a predetermined chunk width on a basis of first data, obtaining an inference result by performing inference by the machine learning model with the chunk width on a basis of second data and the learning result, and calculating an interval abnormality degree for each interval obtained by dividing the chunk width into a plurality of intervals on a basis of the second data and the inference result.

### PRIORITY

The present disclosure contains subject matter related to that disclosed in Japanese Priority Patent Application 2025-6752 filed in the Japan Patent Office on Jan. 17, 2025, 2025-6189 on Jan. 16, 2025, 2025-13776 on Jan. 30, 2025 and 2025-201828 on Nov. 21, 2025, the entire contents of which are hereby incorporated by reference.

### BACKGROUND

The present disclosure relates to an abnormality detecting method and a machine learning device.

Conventionally, in: regard to factory facility maintenance in an industrial machinery field, the application of artificial intelligence (AI) to condition-managed maintenance (Condition Based Maintenance) of a machine system has been underway (see PCT Patent Publication No. WO2019/035279, for example).

### BRIEF DESCRIPTION OF THE DRAWINGS

FIG. 1 is a diagram illustrating a configuration of a computer according to an illustrative embodiment of the present disclosure;

FIG. 2 is a diagram illustrating a configuration of a simulation device according to an illustrative embodiment of the present disclosure;

FIG. 3 is a diagram illustrating an example of a configuration of a machine learning model;

FIG. 4 is a diagram illustrating a three-layer neural network;

FIG. 5 is a diagram illustrating a first setting screen;

FIG. 6 is a diagram illustrating a dialog box;

FIG. 7 is a diagram illustrating an example of data in a data file (sample file);

FIG. 8 is a diagram illustrating the first setting screen;

FIG. 9 is a diagram illustrating a second setting screen;

FIG. 10 is a diagram illustrating the second setting screen;

FIG. 11 is a diagram illustrating a third setting screen;

FIG. 12 is a diagram illustrating an example related to settings of learning and inference;

FIG. 13 is a diagram illustrating a fourth setting screen;

FIG. 14 is a diagram illustrating a first graph screen;

FIG. 15 is a diagram illustrating a second graph screen;

FIG. 16 is a diagram schematically illustrating relation between a chunk width and an interval;

FIG. 17 is a diagram schematically illustrating an internal configuration of a biochemical analysis device;

FIG. 18 is a block diagram of the biochemical analysis device;

FIG. 19 is a diagram illustrating an example of time course data on absorbance;

FIG. 20 is a diagram illustrating a state in which the time course data illustrated in FIG. 19 is arranged;

FIG. 21 is a flowchart illustrating abnormality detection processing in the biochemical analysis device;

FIG. 22 is a diagram schematically illustrating relation between a chunk width and an interval;

FIG. 23 is a diagram illustrating a concrete example of correction processing;

FIG. 24 is a diagram illustrating a configuration of a machine learning device according to an illustrative first embodiment of the present disclosure;

FIG. 25 is a graph illustrating an example of target data;

FIG. 26 is a partial enlarged view of FIG. 25;

FIG. 27 is another partial enlarged view of FIG. 25;

FIG. 28 is a diagram illustrating a first frequency amplitude spectrum corresponding to FIG. 26;

FIG. 29 is a diagram illustrating the first frequency amplitude spectrum corresponding to FIG. 27;

FIG. 30 is a graph illustrating an abnormality degree;

FIG. 31 is a diagram illustrating the first frequency amplitude spectrum in a case where an antialiasing filter is provided;

FIG. 32 is a graph illustrating the abnormality degree in the case where the antialiasing filter is provided;

FIG. 33 is a diagram illustrating a configuration of a machine learning device according to an illustrative second embodiment of the present disclosure;

FIG. 34 is a diagram of assistance in explaining supervised learning;

FIG. 35 is a diagram of assistance in explaining future prediction as an example of a task of the supervised learning;

FIG. 36 is a diagram illustrating a configuration of a machine learning device according to an illustrative third embodiment of the present disclosure;

FIG. 37 is a diagram illustrating the first frequency amplitude spectrum in a case where a sampling frequency is 100 Hz;

FIG. 38 is a diagram illustrating the first frequency amplitude spectrum in a case where the sampling frequency is 89 Hz;

FIG. 39 is a block diagram illustrating a basic configuration of a machine learning device 6;

FIG. 40 is a diagram illustrating a configuration of a machine learning model 80;

FIG. 41 is a diagram schematically illustrating a mode in which input data din is divided into a plurality of chunks, which are input to the machine learning model 80 to be subjected to computation; and

FIG. 42 is a diagram illustrating calculation stages at a time of inference using the input data din and the machine learning model 80.

### DETAILED DESCRIPTION

An illustrative embodiment of the present disclosure will hereinafter be described with reference to the drawings.

### <Configuration of Computer>

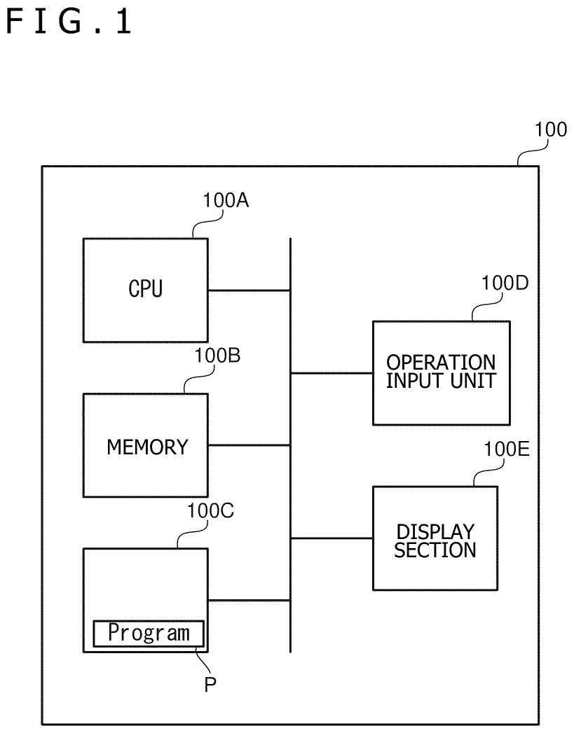

FIG. 1 is a diagram illustrating a configuration of a computer 100 according to the illustrative embodiment of the present disclosure. Incidentally, the configuration of the computer 100 is common to a first, a second, and a third disclosed technology to be described later. The computer 100 functions as a simulation device according to the first disclosed technology to be described later, or a machine learning device 1 according to the second disclosed technology to be described later, or a machine learning device 6 according to the third disclosed technology to be described later. The computer 100 is a personal computer (PC), for example. In a case where the computer 100 is a PC, the computer 100 may be any of a desktop type, a notebook type, and other types.

The computer 100 includes a central processing unit (CPU) 100A, a memory 100B, an auxiliary storage device 100C, an operation input unit 100D, and a display unit 100E.

The CPU 100A includes a control device and a computing device illustrated). The control device interprets commands of a program, and controls various parts of the computer 100. The computing device is a device that performs computation processing.

The memory 100B is a semiconductor storage device that temporarily stores the program or data. Information stored in the memory 100B is erased when power to the computer 100 is turned off.

The auxiliary storage device 100C is constituted by a hard disk drive (HDD), a solid state drive (SSD), or other devices, and stores the program or data. The program stored in the auxiliary storage device 100C is read into the memory 100B. The CPU 100A executes the program read into the memory 100B.

Here, the auxiliary storage device 100C stores a simulation program P. The simulation program P is a program for making the computer 100 function as the machine learning device 1 or the machine learning device 6 to be described later. Details of the machine learning device 1 or the machine learning device 6 will be described later.

The operation input unit 100D is constituted by a keyboard, a mouse, and other devices, and is a device that provides operation input to the computer 100. Information input from the operation input unit 100D is sent to the memory 100B.

The display unit 100E is constituted by, for example, a liquid crystal display or other displays. The display unit 100E converts information obtained from the memory 100B into an image, and outputs the image.

### First Disclosed Technology

The first disclosed technology will next be described. Incidentally, with regard to the description of the first, second, and third disclosed technologies, identical reference numerals given to configurations may denote different configurations. In addition, with regard to the description of the first, second, and third disclosed technologies, suppose that the numbers of equations are independent of each other.

### <Configuration of Simulation Device>

FIG. 2 is a diagram illustrating a configuration of a simulation device 1 according to the illustrative embodiment of the present disclosure. The simulation device 1 is a device capable of simulating learning and inference by machine learning (AI).

The simulation device 1 includes a file storage section 2, a file reading section 3, a model storage section 4, a model computing section 5, a model setting section 6, a display control section 7, an operation input section 8, and a display section 9. The program P (FIG. 1) stored in the auxiliary storage device 100C of the computer 100 is a program for making the computer 100 function as the simulation device 1.

The file storage section 2 stores a data file 21, and is constituted by the auxiliary storage device 100C of the computer 100. The data file 21 is configured as an Excel (registered trademark) file as an example. Incidentally, the file may be, for example, stored into the auxiliary storage device 100C from the outside of the computer 100 via a universal serial bus (USB) interface or a network interface (neither is illustrated in FIG. 1) in the computer 100.

The data file 21 includes data 210. The data 210 is data for performing generally-called unsupervised learning and inference by inputting the data 210 to a machine learning model 40 (to be described later). As will be described later, data to be used for learning and data to be used for inference in the data 210 can be specified.

The file reading section 3 reads the data file 21 from the file storage section 2.

The model storage section 4 stores the machine learning model 40, and is constituted by the auxiliary storage device 100C of the computer 100. The machine learning model 40 is, for example, configured as the program P by MATLAB/Simulink (registered trademark). A concrete example of the machine learning model 40 will be described later.

Respective functions of the file reading section 3, the model computing section 5, the model setting section 6, and the display control section 7 are implemented by execution of the program P by the CPU 100A. Incidentally, the operation input section 8 and the display section 9 respectively correspond to the operation input unit 100D and the display unit 100E in the computer 100.

The model computing section 5 performs simulation by performing computation processing of the machine learning model 40 stored in the model storage section 4. The model setting section 6 makes settings related to the machine learning model 40 stored in the model storage section 4 (the setting of data to be used for learning and inference, the setting of parameters, the setting of a kind of function, and other settings) according to input from the operation input section 8. The simulation of the model computing section 5 is performed according to contents set by the model setting section 6. The display control section 7 performs control for displaying various kinds of screens such as setting screens to be described later on the display section 9 according to input from the operation input section 8.

In n factory facility maintenance in an industrial machinery field, for example, the application of machine learning to the condition-managed maintenance of a machine system has been under way. However, even when a user intends to actually try a selected AI algorithm, data needs to be provided to an AI developer such as an AI vendor. In many cases, the data includes confidential information related to products and manufacturing processes, and is therefore difficult to disclose. Thus, conventionally, there is no choice but to determine suitability for a solution to the problem and challenge of the user by referring to various kinds of cases of the AI vendor or other vendors or making an open problem solved, the open problem being a typical AI performance benchmark (for example, the prediction of housing prices in Boston, the estimation of properties of diesel fuel, or other problems). Needless to say, such an open problem does not match the problem and challenge of the user, and therefore it often becomes clear afterward that the selected AI algorithm is, for example, unsuitable or not suitable very much when applied to the data of the user. Hence, making a selection of an AI algorithm again is disadvantageous to both of the user and the AI vendor.

Even when the user tries AI to find what can be done by AI by using the data obtained by the user as described above, the data needs to be shared with the outside (the AI vendor, an IC manufacturer having an AI solution, or other vendors). That is, there is a risk of taking out the data as confidential information to the outside. In addition, even when only the data is provided, it is difficult to know whether the data is appropriately analyzed on the outside, and an appropriate AI parameter adjustment is difficult unless there is advanced knowledge with regard to a domain in which the user obtained the data. Communicating the domain knowledge from the user to the AI vendor or other vendors is very troublesome, and a communication error tends to occur because of a difference in background knowledge. In addition, the data obtained by the user may not be analyzed immediately on the spot on the same day.

In view of the circumstances as described above, when the simulation device 1 according to the present disclosure is used, an AI effect of unsupervised learning can be recognized effectively by using the data possessed by the user. More specifically, an effect of abnormality detection as a task of unsupervised learning can be recognized. Consequently, effects are produced such as, for example, eliminating the risk of taking out the data as confidential information to the outside or being able to analyze the obtained data on the spot. In particular, the present disclosure introduces a concept of chunks for the setting of data to be input to the machine learning model, as will be described later, and facilitates settings such as those for inputting a plurality of kinds of input data in units of a plurality of pieces of data. This enables consideration as to, for example, what kind of abnormality detection can be performed when various kinds of signals are combined with each other.

### <Configuration of Machine Learning Model>

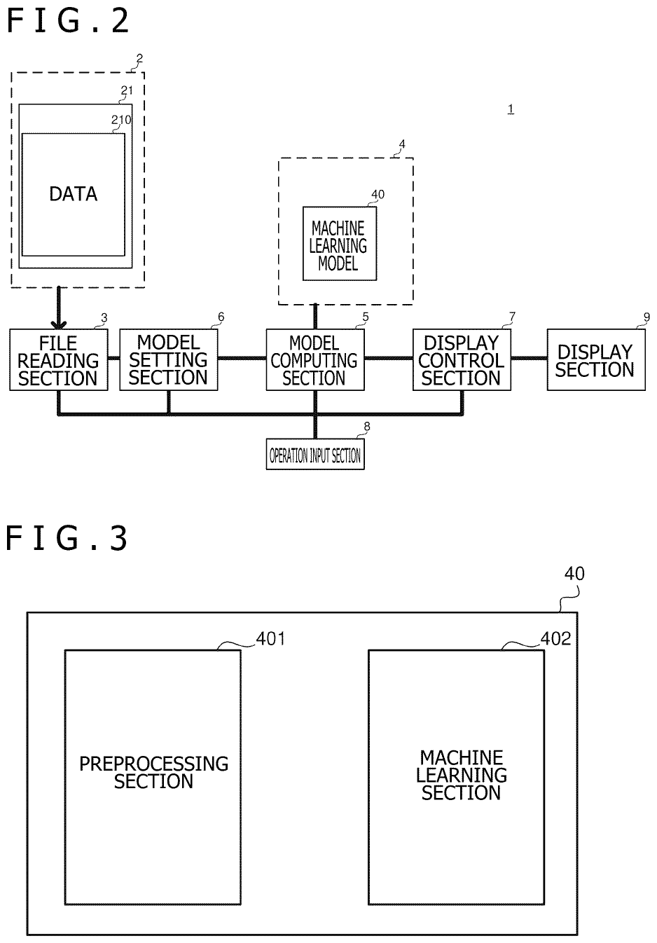

The machine learning model 40 will be described in the following. FIG. 3 is a diagram illustrating an example of a configuration of the machine learning model 40. The machine learning model 40 includes a preprocessing section 401 and a machine learning section 402.

The preprocessing section 401 performs preprocessing before data is input to the machine learning section 402. The preprocessing includes normalization processing. The normalization processing is processing that contains data into a range of approximately 0 to 1 (or −1 to +1). Incidentally, as will be described later, a setting for shift processing or for performing no processing can be made by setting a parameter of the normalization processing.

The preprocessing includes envelope processing. The envelope processing is performed on the data processed by the normalization processing. Incidentally, whether or not to perform the envelope processing can be set, as will be described later.

The preprocessing also includes window function processing and fast Fourier transform (FFT) processing. As will be described later, the window function processing and the FFT processing are performed on the data resulting from the normalization processing and the envelope processing. In addition, as will be described later, the window function processing and the FFT processing are performed for each chunk. As will be described later, whether or not to perform the window function processing and whether or not to perform the FFT processing can be set. As a pattern, it is possible to select the execution of only the window function processing, the execution of only the FFT processing, or the execution of the window function processing and the FFT processing. It is to be noted that there is no limitation to the FFT processing, but frequency analysis processing such as wavelet transformation, for example, may be used.

The machine learning section 402 performs learning and inference on input data. A three-layer neural network 30 as illustrated in FIG. 4, for example, is used as an AI model to be used in the machine learning section 402.

As illustrated in FIG. 4, the three-layer neural network 10 is an AI model including an input layer 10A, a hidden layer 10B, and an output layer 10C. In general, in the three-layer neural network 10, for n-dimensional input data x∈R^{k×n} of a batch size k, an n′-dimensional inference result y∈R^{k×n′} is obtained as y=G (x·α+b)β. Here, α∈R^{n×m} is a weight connecting the input layer 10A and the hidden layer 10B to each other, and β∈R^{m×n′} is a weight connecting the hidden layer 10B and the output layer 10C to each other. In addition, b∈R^{m} is a bias of the hidden layer 10B, and G is an activation function of the hidden layer 10B.

The present embodiment uses an algorithm that can sequentially learn the three-layer neural network 10 with any batch size. In a case where ith learning data {xᵢ∈R^{ki×n}, tᵢ∈R^{ki×n}′} of a batch size ki is obtained, βᵢ that minimizes an error illustrated in the following Equation (1) needs to be obtained.

$$\begin{matrix}[ Math . 1 ] & \\ ‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ & ( 1 )\end{matrix}$$

Incidentally, an ith hidden layer matrix Hᵢ=G(xᵢ·α+b). In addition, t is teacher data corresponding to the inference result y.

An optimized weight βᵢ is calculated by the following Equation (2).

$${P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \qquad ( 2 )$$

$${β}_{i} = {β}_{i - 1} - {P}_{i} {H}_{i}^{T} ( {t}_{i} - {H}_{i} {β}_{i - 1} )$$

Here, P₀ and β₀ are obtained by the following Equation (3).

$${P}_{0} = {( {H}_{0}^{T} {H}_{0} )}^{- 1} \qquad ( 3 )$$

$${β}_{0} = {P}_{0} {H}_{0}^{T} {t}_{0}$$

The learning algorithm is as follows.

The values of the weight α and the bias b are initialized by random numbers.

H₀ for x₀ is calculated, and P₀ and β₀ are calculated.

Pi and βᵢ are sequentially calculated each time the ith learning data of the batch size kᵢ is obtained. Incidentally, a value initialized by a random number may be set as β₀ without the use of the calculation equation of β₀ in Equation (3).

A bottleneck in terms of computational complexity in the foregoing Equation (2) is (I+HᵢPᵢ₋₁Hᵢ^{T})⁻¹. The matrix size of (I+HᵢPᵢ₋₁Hᵢ^{T}) is k×k. Therefore, in a case where k=1, inverse matrix computation can be replaced with reciprocal computation. Hence, the computation is facilitated in a computing device such as a microcomputer by fixing the batch size at k=1. Therefore, in the machine learning model 40, the batch size is fixed at k=1.

In addition, the present embodiment performs learning using an autoencoder. The autoencoder uses input data as teacher data as it is, and performs learning so as to be able to reconstruct the input data as an inference result. That is, in the case of the above description, learning is performed with t=x. The autoencoder does not necessitate the generation of separate teacher data, and is therefore a kind of unsupervised learning algorithm.

According to the AI model in such a machine learning section 402, learning can be performed by a computing device such as a microcomputer in an edge device. That is, when such on-device learning is introduced into, for example, the detection of an abnormality in a motor or other detection, an effect of the abnormality detection can be confirmed by simulation. Incidentally, in a case where the preprocessing section 401 does not perform the FFT processing, the input data x is time series data, and in a case where the preprocessing section 401 performs the FFT processing, the input data x is data in a frequency domain.

The machine learning section 402 calculates an abnormality degree by a loss function L(y, t) representing an error between the inference result y and the teacher data t. Mean Absolute Error (MAE) or Mean Squared Error (MSE), for example, is used as the loss function. In a case where the loss function is MAE, the loss function L is expressed as in the following Equation (4).

$$\begin{matrix}[ Math . 2 ] & \\ L ( y , t ) = \frac{1}{{n}^{′}} \sum \vert y - t \vert & ( 4 )\end{matrix}$$

In addition, in a case where the loss function is MSE, the loss function L is expressed as in the following Equation (5).

$$\begin{matrix}[ Math . 3 ] & \\ L ( y , t ) = \frac{1}{{n}^{′}} \sum {\vert y - t \vert}^{2} & ( 5 )\end{matrix}$$

Because learning is performed by using the autoencoder, the abnormality degree is calculated with the loss function L(y, t)=L(y, x).

### <GUI>

Next, a description will be made of a Graphical User Interface (GUI) that enables settings related to simulation in the simulation device 1 according to the present embodiment. Examples of various kinds of screens to be described in the following are displayed on the display section 9 by the display control section 7 (FIG. 2). Selections and settings on the various kinds of setting screens or switching between screens or other settings is performed on the basis of input by the operation input section 8. Contents set on the various kinds of setting screens are set by the model setting section 6.

### <<First Setting Screen>>

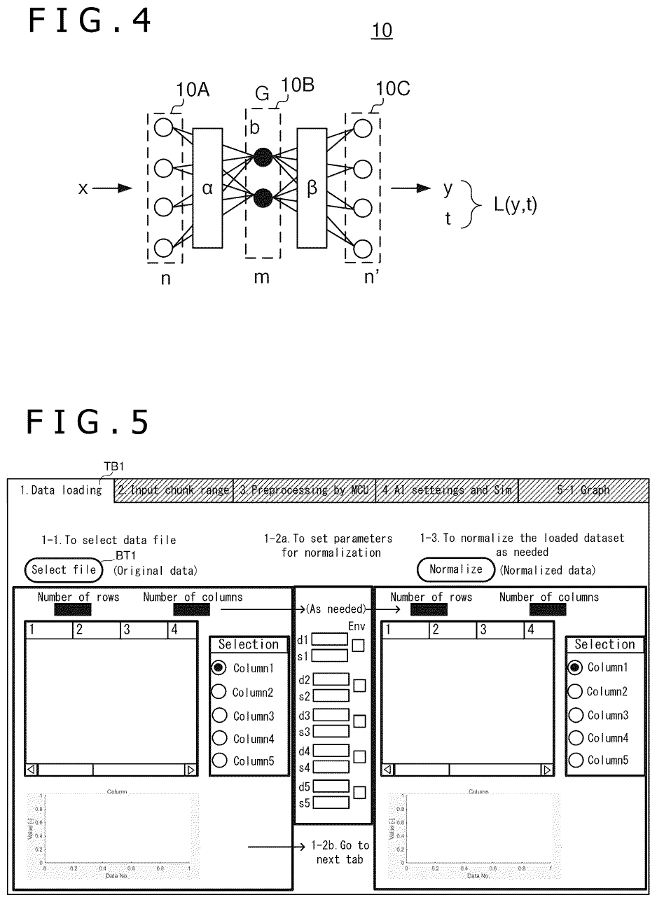

When the program P is started, a first setting screen illustrated in FIG. 5 is displayed. The first setting screen allows reading a data file and making settings for the preprocessing as needed. Tabs are displayed so as to be arranged side by side horizontally on the upper side of the first setting screen. The setting screen can be switched by pressing a tab. FIG. 5 (first setting screen) is a state in which a tab TB1 of “1. Data loading” is pressed.

The first setting screen displays a selection button BT1 for selecting a data file. A dialog box illustrated in FIG. 6 is displayed by pressing the selection button BT1. The dialog box displays a list of file names in a selection section SA1. A file name selected in the selection section SA1 is displayed in a file name display section DA1 on a lower side. When a determination button BT2 is pressed in the dialog box, the data file of the file name displayed in the file name display section DA1 is read by the file reading section 3. Here, an Excel file with an extension xlsx can be selected.

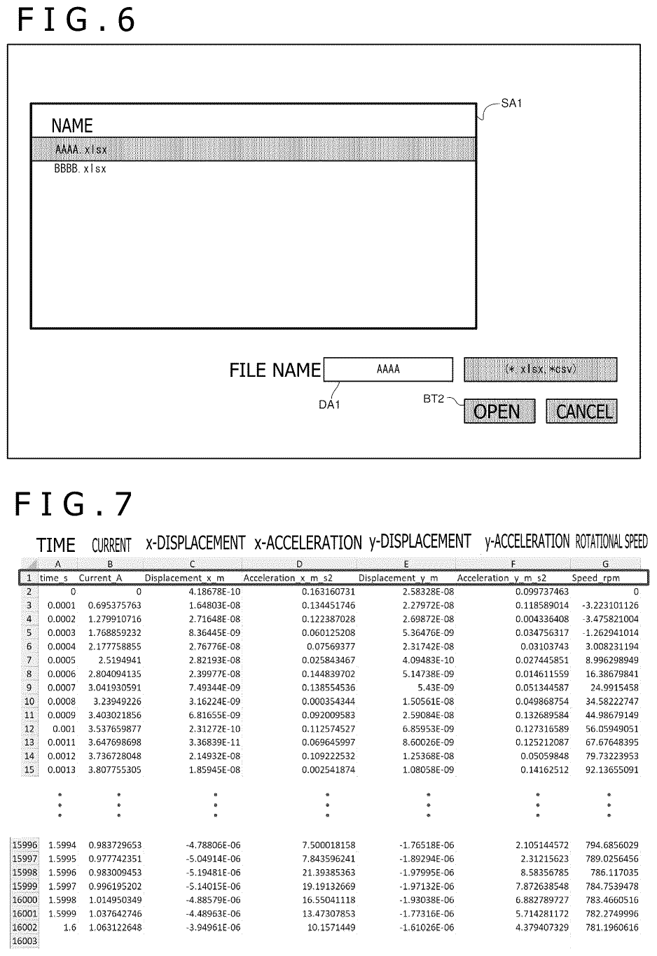

Here, FIG. 7 is a diagram illustrating an example of data in the data file (sample file). The data of FIG. 7 is, as an example, time series data of various kinds of signals in a case of supposing that the inner ring raceway of a bearing supporting a motor output shaft is damaged, and the damage deteriorates stepwise with the passage of time. Specifically, time [s] is stored in an A-column, a motor current [A] is stored in a B-column, an x-direction displacement [m] is stored in a C-column, an x-direction acceleration [m/s\hat{ }2] is stored in a D-column, a y-direction displacement [m] is stored in an E-column, a y-direction acceleration [m/s\hat{ }2] is stored in an F-column, and an output shaft rotational speed [rpm] is stored in a G-column. Incidentally, in each column, a first row stores a variable name. In addition, in FIG. 7, settings are made such that, as an example, first 4000 pieces of data represent a normal state and the degree of the damage deteriorates in each subsequent unit of 4000 pieces of data. In the following, a description will be made supposing that such a file is read.

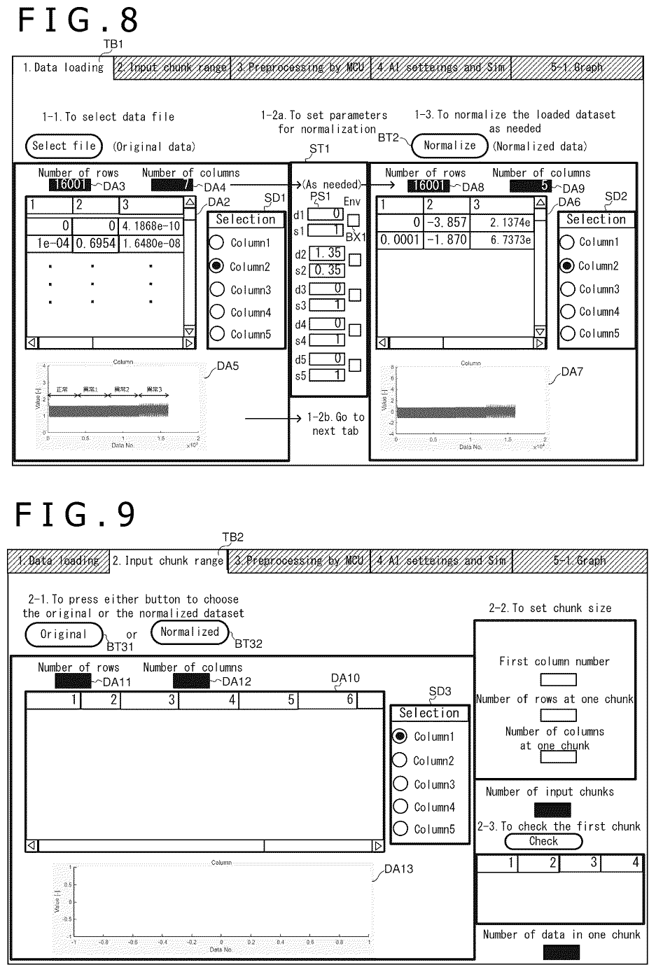

When the data file is read, as illustrated in FIG. 8, a table display section DA2 in the first setting screen displays the data included in the read data file in a table format. Incidentally, the data is read with the first row of the data file ignored. The user can thereby check whether the data is read correctly. In addition, a row count display section DA3 displays the number of rows of the read data, and a column number display section DA4 displays the number of columns of the read data. The table display section DA2 displays all of the read data.

Meanwhile, when the data file is read, as illustrated in FIG. 8, a graph display section DA5 in the first setting screen makes a graph display of the read data for each column. The graph display is made with an axis of abscissas indicating a data number, and with an axis of ordinates indicating a data value. A column selection section SD1 allows the first to fifth columns to be selected by a radio button. A graph display of the data of the first column is made by default. However, the column for which the graph display is made can be changed by pressing the above-described radio button. Incidentally, graph display of the sixth and subsequent columns may not be made. However, this does not mean that the data is not read. In the example of FIG. 8, a graph display of the data of the second column (Column 2) (that is, the motor current) is selected.

A preprocessing setting section ST1 is displayed at a center in a left-right direction of the first setting screen (FIG. 8). Settings related to the normalization processing and envelopes can be made in the preprocessing setting section ST1. Settings of the normalization processing and the envelope processing can be made individually for each of the first to fifth columns of the read data.

The normalization processing is performed by the following Equation (6).

$$\begin{matrix}[ Math . 4 ] & \\ \frac{{x}_{column i} - di}{{s}_{i}} & ( 6 )\end{matrix}$$

where xcolumn i is the data of an ith column, and di and si are parameters for the data of the ith column.

A parameter setting section PS1 in the preprocessing setting section ST1 allows the setting of the parameters (di, si) for each of the first to fifth columns. A setting for shift processing or for performing no processing can be made according to the parameter setting.

In addition, a check box Bx1 in the preprocessing setting section ST1 is provided for each of the first to fifth columns. The envelope processing is performed for a column for which the check box Bx1 is checked. The envelope processing is not performed for a column for which the check box Bx1 is not checked.

When a preprocessing button BT2 in the first setting screen is pressed, preprocessing is performed on the data of the first to fifth columns according to the settings in the preprocessing setting section ST1. A table display section DA6 in the first setting screen displays the data after being preprocessed in a table format. In this case, the data of the first to fifth columns is displayed. A graph display section DA7 displays data after the preprocessing in a column selected by a radio button in a selection section SD2. A display format is similar to that of the graph display section DA5. Incidentally, a row display section DA8 and a column display section DA9 respectively display the number of rows and the number of columns of the data displayed in the table display section DA6. The column display section DA9 displays the number of columns=5. In the example of FIG. 8, the graph display section DA7 displays the data after the preprocessing in the second column (Column 2) selected in the selection section SD2.

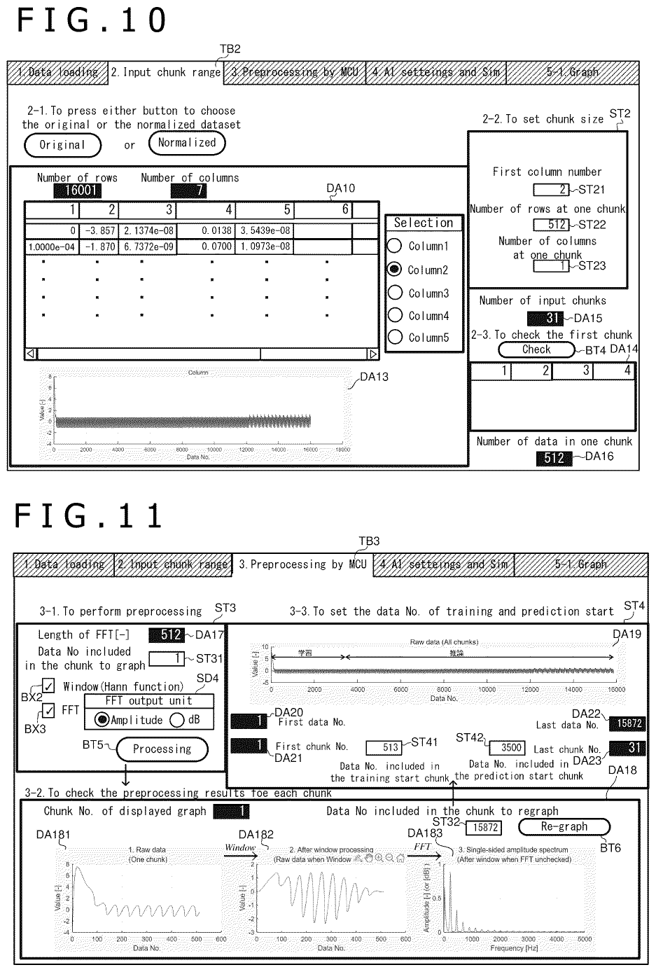

Incidentally, in a case where the preprocessing is not necessary, the screen is changed by pressing a tab TB2 (FIG. 9 to be described later) without pressing the preprocessing button BT2.

### <<Second Setting Screen>>

When a tab 2 (“2. Input chunk range”) is pressed, a second setting screen as illustrated in FIG. 9 is displayed. The second setting screen displays data setting buttons BT31 and BT32, and one of the buttons is pressed.

When the data setting button BT31 is pressed, the data read on the first setting screen (original data) is used as it is as data to be input to the machine learning model 40. When the data setting button BT32 is pressed, data obtained by subjecting the data read on the first setting screen to the preprocessing set on the first setting screen is used as data to be input to the machine learning model 40.

The data selected to be used by one of the data setting buttons BT31 and BT32 is displayed in a table display section DA10 and a graph display section DA13. The table display section DA10 makes display in a table format. The display of the graph display section DA13 can be switched among the first to fifth columns by selecting a column by a radio button in a column selection section SD3.

FIG. 10 is a diagram illustrating a state in a case where the data setting button BT32 is pressed on the second setting screen (that is, the usage of the data after the preprocessing). In this case, the graph display section DA13 displays the data of the second column selected in the column selection section SD3.

The second setting screen displays a chunk setting section ST2. A chunk is one cluster of data when sequential input to the machine learning model 40 (machine learning section 402) is performed. The chunk setting section ST2 includes a column number setting section ST21, a row count setting section ST22, and a column count setting section ST23. The column number setting section ST21 allows input of a column number in usage data (data selected by the data setting button BT31 or BT32), the column number indicating a first column of the input data to be input to the machine learning model. The row count setting section ST22 allows input of the number of rows of one chunk in the usage data. The column count setting section ST23 allows input of the number of columns of one chunk in the usage data.

In the example of FIG. 10, “2” is input to the column number setting section ST21, “512” is input to the row count setting section ST22, and “1” is input to the column count setting section ST23. Thus, the second column of the usage data is set as the first column of the input data, and a cluster of data of 512 rows and 1 column is set as one chunk. That is, the data of the second column (motor current in FIG. 7) is selected as the input data.

Incidentally, a plurality of columns of data, that is, a plurality of kinds of signal data or other data can be set as the input data by setting a value of two or more in the column count setting section ST23. For example, it is possible to set the data of the motor current and the x-direction displacement in FIG. 7 as the input data.

A chunk count display section DA15 displays the number of chunks calculated from the number of rows of the usage data and the number of rows of one chunk (number of chunks=31 in the example of FIG. 10). In addition, when a check button BT4 in the second setting screen is pressed, a table display section DA14 displays a first chunk in a table format. It is thereby possible to check whether the chunks are set appropriately. At this time, a data count display section DA16 displays the number of pieces of data included in one chunk. The number of pieces of data is the same as the value of a product of the number of rows and the number of columns of one chunk (number of pieces of data=512 in the example of FIG. 10).

### <<Third Setting Screen>>

When a tab TB3 (“3. Preprocessing by MCU”) is pressed, a third setting screen as illustrated in FIG. 11 is displayed. On the third setting screen, the application of the preprocessing such as FFT that can be performed in an microcomputer (MCU) is considered.

The third setting screen displays a preprocessing setting section ST3. In the preprocessing setting section ST3, whether or not to apply the window function processing and whether or not to apply the FFT processing are each set. Incidentally, adoptable as the window function processing is a Hann window, Hamming window, a Gauss window, a triangular window, a Kaiser window, a Chebyshev window, a Blackman window, or other windows. Specifically, whether or not to perform the window function processing is set by a check box BX2. Whether or not to perform the FFT processing is set by a check box BX3. In addition, an output unit selection section SD4 allows selection of a unit of an FFT processing result (Amplitude or dB) by a radio button.

Incidentally, the window function processing and the FFT processing are performed for each chunk. An algorithm suitable for calculation in an MCU is set as the FFT processing or other processing. Only a single-sided amplitude spectrum is used as the data after the FFT processing. Thus, for an FFT length (number of pieces of data included in one chunk), the number of pieces of data after the FFT processing is (FFT Length/2)+1. However, depending on the algorithm implemented in the MCU, a frequency component of highest frequency of the single-sided amplitude spectrum is discarded, and the number of pieces of data may become (FFT Length/2). Incidentally, the FFT processing may be allowed to select a case of using only amplitude, a case of using only phase, a case of using both of amplitude and phase, or other cases.

In addition, in the preprocessing setting section ST3, an FFT length display section DA17 displays the FFT length.

When a preprocessing button BT5 is pressed, the preprocessing set in the preprocessing setting section ST3 is performed, and processing results are displayed in a result display section DA18. The processing results are displayed for each chunk. Incidentally, a data number included in the displayed chunk can be set in a data number setting section ST31 in the preprocessing setting section ST3. Here, in a case where the number of columns of the chunk is plural, data numbers are serial numbers in all of the chunk when numbers are allocated from 1 in order to data of different columns in same rows in order from a small number row. For example, when the number of columns of the chunk is three, numbers are allocated in order of a first column, a second column, and a third column of a first row, a first column, a second column, and a third column of a second row, . . . . In the example of FIG. 10 described above, the set chunk has 512 rows and 1 column, and therefore data numbers from 1 to 512 represent the same first chunk.

In the result display section DA18, a raw data (Raw data) display section DA181, a post-window function processing display section DA182, and a post-FFT processing display section DA183 are displayed from a left to a right. The raw data display section DA181 displays the raw data of one chunk (data before being processed). The post-window function processing display section DA182 displays data obtained by performing the window function processing on the data of the one chunk. The post-FFT processing display section DA183 displays data obtained by performing the FFT processing on the data after the window function processing. Incidentally, in each of the raw data display section DA181, the post-window function processing display section DA182, and the post-FFT processing display section DA183, graph display is made with an axis of abscissas indicating the data number (however, the data number is a serial number in a case where first data in the target chunk is set to have a number 1), and with an axis of ordinates indicating the data value.

However, in a case where the window function processing is not applied, but only the FFT processing is performed, for example, the post-window function processing display section DA182 displays the raw data. In a case where neither of the window function processing and the FFT processing is applied, the raw data display section DA181, the post-window function processing display section DA182, and the post-FFT processing display section DA183 each display the raw data. In any case, the data displayed in the post-FFT processing display section DA183 is data to be input to the machine learning section 402 (three-layer neural network 10).

FIG. 11 represents an example of display of the processing results in a case where the window function processing and the FFT processing are both applied. Incidentally, the result display section DA18 displays a data number setting section ST32. A data number corresponding to a chunk to be redisplayed in the result display section DA18 can be set in the data number setting section ST32. When a redisplay button BT6 is pressed, processing results are redisplayed in the result display section DA18.

Next, a learning and inference setting section ST4 (FIG. 11) in the third setting screen will be described. The learning and inference setting section ST4 displays a raw data display section DA19. The raw data display section DA19 makes graph display of the data (data before being processed) of all of the chunks set on the second setting Screen. The display is made with an axis of abscissas indicating the data number, and with an axis of ordinates indicating the data value.

A first data number display section DA20 and a first chunk number display section DA21 are displayed at a left end below the raw data display section DA19. The first data number display section DA20 displays a first number of data numbers (“1” in FIG. 11). The first chunk number display section DA21 displays the number of the first chunk (“1” in FIG. 11).

A last data number display section DA22 and a last chunk number display section DA23 are displayed at a right end below the raw data display section DA19. The last data number display section DA22 displays a last data number. The last chunk number display section DA23 displays a last number of chunk numbers. In the example of FIG. 11, because the chunks are set to have 512 rows and 1 column in the example of FIG. 10, and the number of pieces of data of one column is 16001 as illustrated in FIG. 7, the number of chunks is 31 (last chunk number), and the last data number is 31×512=15872.

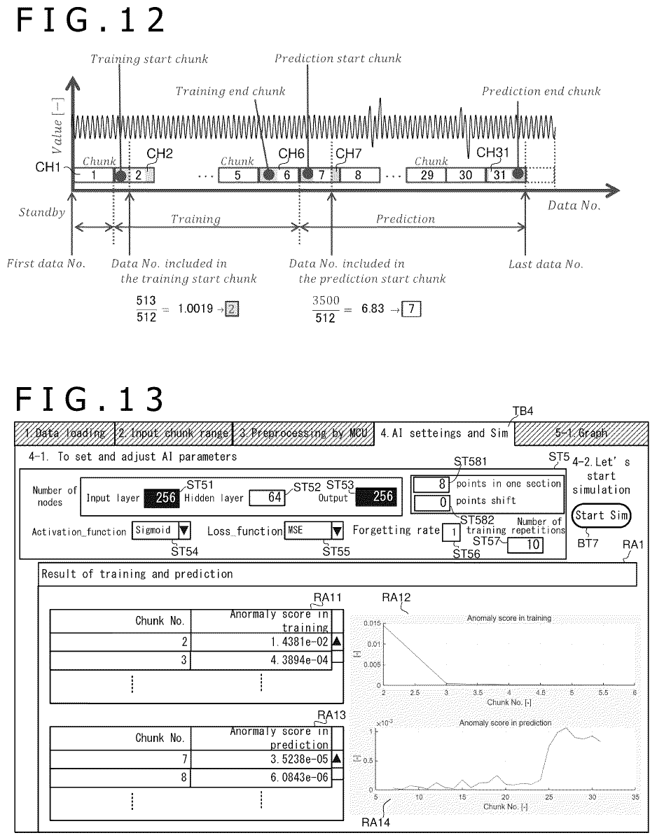

Learning (Training) and inference (Prediction) in the machine learning section 402 are performed in chunk units. First, one of data numbers included in a chunk at which learning is desired to be started is input and set to a data number setting section ST41. FIG. 12 is a diagram of settings of learning and inference for a sequence of raw data similar to that of FIG. 11. A current increase in the motor current as the data of the second column in the example of FIG. 7 is observed at a time of a start of the motor. In a case where this current increase is not desired to be learned, it is effective to start learning at a second chunk CH2 (chunk number=2). Accordingly, when 513, for example, which is a data number included in the second chunk CH2, is set, the learning is started at the second chunk CH2, and a first chunk CH1 is not used for the learning.

Next, one of data numbers included in a chunk at which inference is desired to be started is input and set to a data number setting section ST42 (FIG. 11). The motor current in the example of FIG. 7 makes a transition to an abnormal state from a data number 4000. Because there is a normal state before that data number, a data number 3500 is set as an example here, and only the normal state is used for the learning. Incidentally, as illustrated in FIG. 12, the data number 3500 corresponds to a chunk CH7 of a chunk number=7. Thus, in the example of FIG. 12, the chunk CH1 is not used for the learning, chunks CH2 to CH6 are used for the learning, and chunks from the chunk CH7 to a last chunk CH31 are used for the inference.

### <<Fourth Setting Screen>>

When a tab TB4 (“4. AI Settings and Sim”) is pressed, a fourth setting screen as illustrated in FIG. 13 is displayed. The fourth setting screen is a screen for setting parameters of the machine learning section 402, performing simulation, and checking a simulation result.

The fourth setting screen illustrated in FIG. 13 displays an AI parameter setting section ST5. The AI parameter setting section ST5 includes an input node count setting section ST51, a hidden layer node count setting section ST52, and an output node count setting section ST53. The input node count setting section ST51 displays the number of nodes of the input layer 10A (that is, the value of n described above). The number of nodes of the input layer is calculated by multiplication of the number of rows and the number of columns of one chunk of the input data. That is, the data of one chunk corresponds to data of batch size 1. Incidentally, in a case where the data after the FFT processing is used, the number of pieces of data in one chunk is equal to the number in the single-sided amplitude spectrum. In the example of FIG. 13, because the data after the FFT processing is input to the machine learning section 402 as illustrated in FIG. 11, the number of pieces of data in one chunk is reduced from 512 to 256 (=FFT Length/2=512/2), and this 256 is set as the number of input nodes (as described above, an example is used in which a frequency component of highest frequency of the single-sided amplitude spectrum is discarded).

The number of nodes of the hidden layer 10B (that is, the value of m described above) can be input to the hidden layer node count setting section ST52. The output node count setting section ST53 displays the number of nodes of the output layer 10C (that is, the value of n′ described above). Because of the autoencoder, the number of output nodes coincides with the number of input nodes.

The AI parameter setting section ST5 also includes an activation function setting section ST54, a loss function setting section ST55, and a forgetting rate setting section ST56. The activation function setting section ST54 allows selection of a kind of activation function of the hidden layer 10B. Sigmoid, ReLU, or other functions, for example, can be set as the activation function.

The loss function setting section ST55 allows selection of a kind of loss function used for the calculation of the abnormality degree in the machine learning section 402. MAE or MSE, for example, can be set as the loss function.

The forgetting rate setting section ST56 allows input of the value of a forgetting rate. The forgetting rate is a parameter indicating a degree to which a learning result is forgotten. Methods for not reflecting the learning result include, for example, the usage of a past learning result, the initialization of the learning result, and other methods. A forgetting rate=1 indicates that a previous learning result is not forgotten at all. A forgetting rate=0 indicates that all is forgotten.

In addition, the AI parameter setting section ST5 also displays a learning repetition count setting section ST57. The learning repetition count setting section ST57 allows a setting of the number of times that the learning is repeated.

In addition, the AI parameter setting section ST5 also displays an interval abnormality degree setting section ST58. The interval abnormality degree setting section ST58 allows a setting for the calculation of an interval abnormality degree to be described later. The interval abnormality degree setting section ST58 includes an interval width setting section ST581 and a shift amount setting section ST582. The number of pieces of data (number of points) in one interval of the interval abnormality degree is set in the interval width setting section ST581. A shift amount of the interval at a time of calculation of the interval abnormality degree is set in the shift amount setting section ST582. Incidentally, in the interval width setting section ST581, the interval width may be consequently set by setting the number of intervals in one chunk.

When the settings of all of the setting items are completed by using the setting screens described above, and a simulation start button BT7 is depressed, the model computing section 5 performs simulation according to the contents set by the model setting section 6. In this case, the data is sequentially input to the machine learning section 402 in chunk units, and unsupervised learning is performed by sequentially updating β by the algorithm described above. When the data is input, the data is input to the respective nodes of the input layer 10A in order of the data numbers in the chunk. The inference of the machine learning section 402 is also performed during the learning. In addition, the inference of the machine learning section 402 is also performed after completion of the learning. An inference result is calculated for each chunk. In addition, the abnormality degree is calculated for each chunk on the basis of the inference result, the input data, and the loss function. Further, the interval abnormality degree is also calculated in addition to the abnormality degree for each chunk. The interval abnormality degree is calculated on the basis of the inference result, the input data, and the loss function.

As illustrated in FIG. 13, example, the simulation result is displayed in a result display section RA1 in the fourth setting screen. The result display section RA1 displays an abnormality degree table display section RA11 and an abnormality degree graph display section RA12 in an upper part thereof. The abnormality degree table display section RA11 displays the abnormality degree for each chunk at the time of the learning in a table format. The abnormality degree graph display section RA12 displays the abnormality degree for each chunk at the time of the learning in a graph format. The abnormality degree table display section RA11 and the abnormality degree graph display section RA12 both display chunk numbers and abnormality degrees in correspondence with each other.

The result display section RA1 displays an abnormality degree table display section RA13 and an abnormality degree graph display section RA14 in a lower part thereof. The abnormality degree table display section RA13 displays the abnormality degree for each chunk at the time of the inference after the completion of the learning in a table format. The abnormality degree graph display section RA14 displays the abnormality degree for each chunk at the time of the inference after the completion of the learning in a graph format. The abnormality degree table display section RA13 and the abnormality degree graph display section RA14 both display chunk numbers and abnormality degrees in correspondence with each other.

Here, when the simulation start button BT7 is pressed in a state in which there is input to the learning repetition count setting section ST57, the learning using all of the chunks for the learning (chunks CH2 to CH6 in the example of FIG. 12) is reused the number of times set in the learning repetition count setting section ST37. That is, when up to the last chunk is used, a return is made to the first chunk to resume the learning. It is thereby possible to perform sufficient learning easily even in a case where it is not easy to prepare long-term data for realizing the learning.

### <<Graph Screen>>

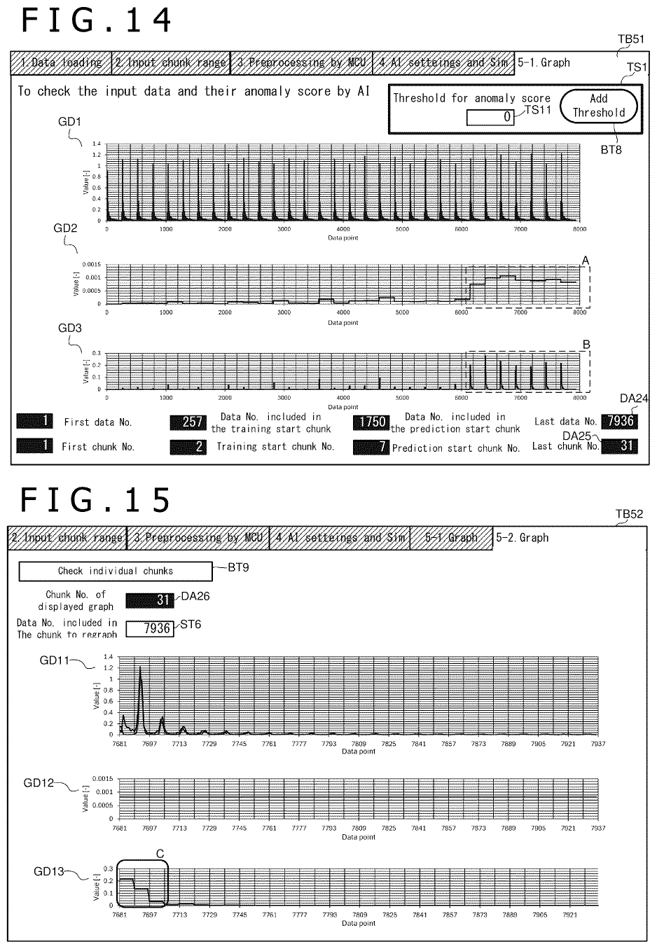

When a tab TB51 (“5-1. Graph”) is pressed, a first graph screen as illustrated in FIG. 14 is displayed. The first graph screen displays a graph display section GD1 in an upper part thereof, displays a graph display section GD2 in a middle part thereof, and displays a graph display section GD3 in a lower part thereof. The graph display section GD1 displays the values of the input data with regard to all of the data (data including all of the chunks) input to the machine learning section 402. An axis of abscissas indicates the data number. Incidentally, in the example of FIG. 14, the data obtained by performing the window function processing and the FFT processing for each chunk on the third setting screen is set as the input data, and therefore data from a peak like a spike to the front of a next peak corresponds to one chunk (number of pieces of data of one chunk=FFT Length/2). In addition, because of the FFT processing, the last data number 15872 on the third setting screen (FIG. 11) becomes 7936, which is half of the last data number (last data number display section DA24). Incidentally, the last chunk number is 31, which is the same as on the third setting screen (last chunk number display section DA25).

The graph display section GD2 displays the value of the abnormality degree for each chunk with regard to all of the data input to the machine learning section 402. An axis of abscissas indicates the data number. The graph display section GD3 displays the value of the interval abnormality degree with regard to all of the data input to the machine learning section 402. An axis of abscissas indicates the data number.

When a threshold value of the abnormality degree is input to a threshold value input section TS11 in a threshold value setting section TS1 at an upper right of the graph screen, and a setting button BT8 is pressed, a set threshold value TH is displayed in the graph display section GD2.

In addition, when a tab TB52 (“5-2. Graph”) is pressed, a second graph screen as illustrated in FIG. 15 is displayed. The second graph screen displays graph display sections GD11, GD12, and GD13. The graph display section GD11 displays the data input to the machine learning section 402 in one chunk and a result of inference by the machine learning section 402 in comparison with each other. The graph display section GD12 display the abnormality degree in the one chunk. The graph display section GD13 displays the abnormality degree in the one chunk. In each of the graph display sections GD11, GD12, and GD13, an axis of abscissas is displayed as the data number.

Incidentally, a chunk number display section DA26 and a data number setting section ST6 are displayed above the graph display section GD11. The chunk number display section DA26 displays the chunk number of the chunk displayed in the graph display sections GD11, GD12, and GD13. The last chunk number is displayed by default. The data number setting section ST6 allows a setting of a data number included in a chunk to be redisplayed in the graph display sections GD11, GD12, and GD13. When a redisplay button BT9 is pressed after setting in the data number setting section ST6, redisplay is made in the graph display sections GD11, GD12, and GD13.

### <Example of Abnormality Detection>

An example of abnormality detection will be described by using the various kinds of screens described above. A data file including time series data as illustrated in FIG. 7 was read on the first setting screen (FIG. 8), and the normalization processing was performed on the data of the motor current (second column). Then, the usage of data after the normalization processing was selected on the second setting screen (FIG. 9), and chunk settings were made (set chunk size=512×1). Then, on the third setting screen (FIG. 11), the window function processing and the FFT processing were performed for each chunk, and chunks at which to start learning and inference were set. As a result of the FFT processing, the number of pieces of data in one chunk becomes FFT Length/2=512/2=256. Hence, Chunk Width=FFT Length/2. Incidentally, in a case where the FFT processing is not performed, the chunk width is the above-described chunk size. In addition, ¼ as a first part of the data illustrated in FIG. 7 is set as normal data, and ¾ as a second part of the data is set as abnormal data. Thus, a chunk number at which to start inference was set at 7, and learning was performed by using chunks of chunk numbers=2 to 6 as normal data. In addition, the abnormal data is changed stepwise such that an abnormal state is strengthened toward an end of the second part.

Then, on the fourth setting screen (FIG. 13), various kinds of parameters for machine learning are set, and simulation is performed. When the first graph screen (FIG. 14) is displayed, the graph display section GD2 displays the abnormality degree for each chunk (chunk width=256). As illustrated in FIG. 14, the abnormality degree is increased in a broken line part A as a rearmost part.

In addition, on the first graph screen, the graph display section GD3 displays the interval abnormality degree. The interval abnormality degree is an abnormality degree calculated for each interval obtained by dividing the chunk width into a plurality of intervals. On the fourth setting screen (FIG. 13), the number of pieces of data (number of points) in one interval of the interval abnormality degree is set in the interval width setting section ST581. A shift amount of the intervals at a time of calculation of the interval abnormality degree is set in the shift amount setting section ST582. FIG. 16 conceptually illustrates relation between a chunk width CW and an interval SC. When the shift amount is 0, the interval SC is set at a start of a first chunk (=inference start chunk) among inference target chunks. In FIG. 16, the first chunk among the inference target chunks is represented as a “chunk #1.” In the example of FIG. 16, the chunk width CW is divided into eight intervals by the interval SC.

In the example of FIG. 13, the number of pieces of data of one interval is set at 8 in the interval width setting section ST581, and the shift amount is set at 0 in the shift amount setting section ST582. Thus, the chunk width is divided into intervals whose number is Chunk Width/Number of Pieces of Data of One Interval=256/8=32. The chunk #1 in FIG. 16 is the inference start chunk of the chunk number=7. Hence, the graph display section GD3 in FIG. 14 displays the interval abnormality degree for each of the 32 intervals. High interval abnormality degrees occur in a broken line part as a rearmost part.

The second graph screen of FIG. 15 displays the abnormality degree in the last chunk (chunk number=31) in the graph display section GD12, and displays the interval abnormality degree in the last chunk in the graph display section GD13. Thus, while the graph display section GD12 displays a fixed value, the graph display section GD13 displays the interval abnormality degree of each interval. It thereby becomes clear that the interval abnormality degree in a start part of the last chunk is high (frame line C).

It is thus possible to check the presence or absence of an overall abnormality according to the abnormality degree of each chunk, and further identify which part of the data is particularly abnormal, that is, a local abnormal part according to the interval abnormality degree. When the abnormal part of the data can be identified, because the band of the abnormal part is associated with a predetermined abnormality mode, it is possible to determine that there is a strong possibility of the occurrence of the predetermined abnormality mode. For example, in the above-described example, when the data of the motor current after the FFT processing is input to the machine learning model, and it is found that as in the example of FIG. 15, the interval abnormality degree is high in a part around a start of the chunk, that is, in a low-frequency part, for example, when the abnormal part is identified as a 400-KHz band, it is found that there is a strong possibility that a bearing damage abnormality has occurred. Alternatively, when the abnormal part can be identified as a band of a rotation frequency (for example, 60 Hz) of the motor, for example, it is found that there is a strong possibility that an abnormality in synchronism with the rotation frequency has occurred.

In addition, when the shift amount is set to a value larger than 0, as illustrated on a lower side of FIG. 16, the intervals are shifted rearward from a start of the first chunk of the inference target by the shift amount, and then the interval abnormality degree is calculated. It is thereby possible to suppress omitting abnormality detection even when there is an abnormality at a boundary between chunks adjacent to each other (at a boundary between the chunk #1 and a chunk #2 in FIG. 16 or other boundaries).

### <Biochemical Analysis Device>

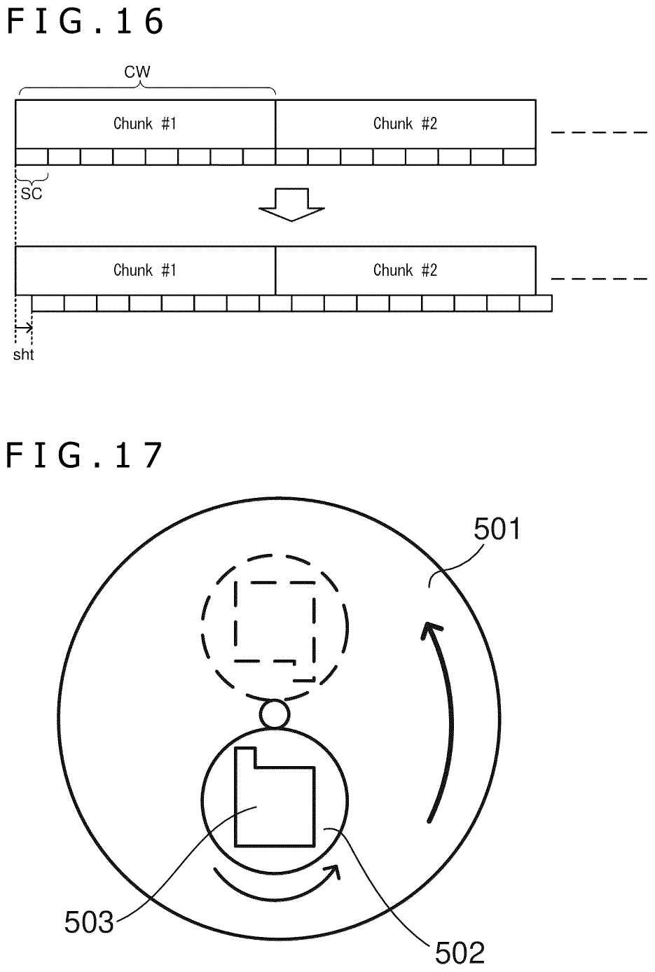

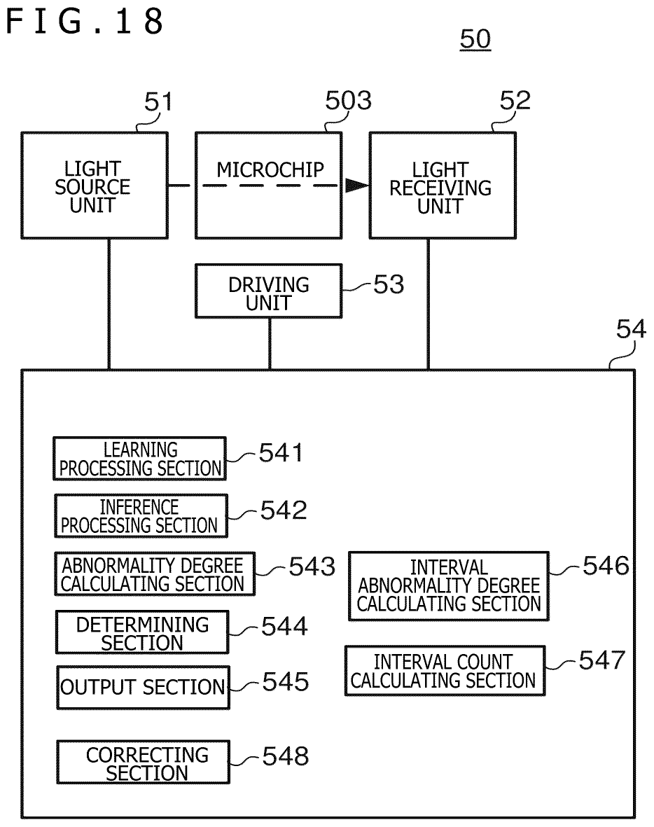

A biochemical analysis device according to an embodiment of the present disclosure will next be described. FIG. 17 is a diagram schematically illustrating an internal structure of a biochemical analysis device 50. FIG. 18 is a block diagram of the biochemical analysis device 50.

As illustrated in FIG. 17, the biochemical analysis device 50 includes a rotary table 501 and a chip holding unit 502. In addition, as illustrated in FIG. 18, the biochemical analysis device 50 includes a light source unit 51, a light receiving unit 52, a driving unit 53, and a measurement control unit 54.

The biochemical analysis device 50 is a device for analyzing and testing a sample for biochemical analysis such as blood, for example, by using a microchip 503. The rotary table 501 is rotationally driven by the driving unit 53. The chip holding unit 502 is rotatably fixed to the rotary table 501. The chip holding unit 502 is rotationally driven by the driving unit 53 independently of the rotary table 501. The microchip 503 is held by the chip holding unit 502.

A blood collected from a subject is injected into the microchip 503 by sucking the blood by capillary action, for example. Then, the microchip 503 is fitted to the chip holding unit 502. An analytical test in the biochemical analysis device 50 includes a pre-processing operation of preparing a test liquid according to test items and a measuring operating of measuring the absorbance of the test liquid obtained by the pre-processing operation.

The pre-processing operation is performed by using a centrifugal force that acts on the microchip 503 when the rotary table 501 is rotationally driven. The pre-processing operation includes separating processing of separating a measurement target liquid from the sample, a weighing processing of collecting a certain amount of the measurement target liquid, mixing and reacting processing of preparing the test liquid by mixing and reacting the measurement target liquid and a reagent with each other, and feeding processing of feeding the prepared test liquid into a measurement cell in the microchip 503. Each piece of processing in the pre-processing operation is sequentially performed while the orientation of the microchip 503 is changed by the chip holding unit 502.

After the pre-processing operation, the measuring operation is performed on the measurement cell. In this case, the measurement cell of the microchip 503 is irradiated with light from the light source unit 51, and the light transmitted through the test liquid within the measurement cell is received by the light receiving unit 52. The measurement control unit 54 measures the absorbance on the basis of the amount of the light received by the light receiving unit 52. The measurement control unit 54 obtains temporal changes (referred to as a time course) in the absorbance.

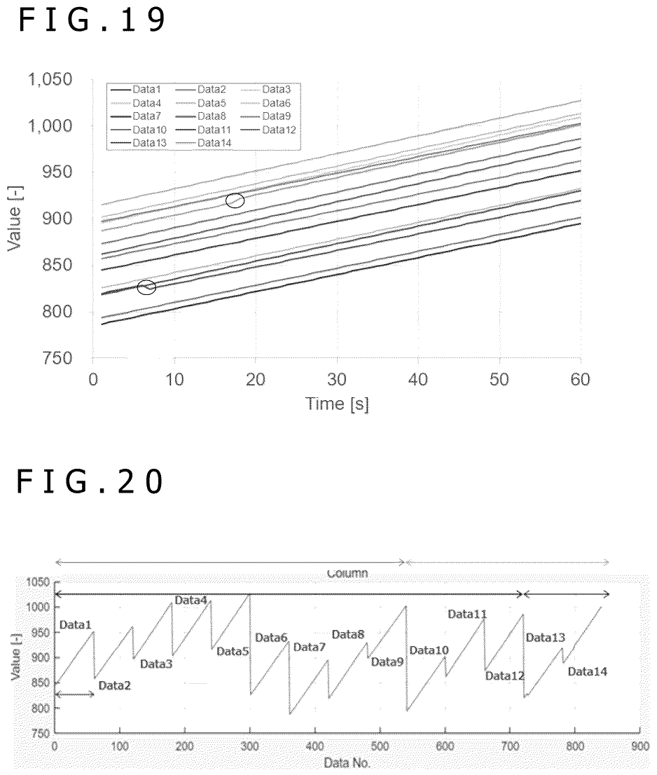

FIG. 19 illustrates an example of time course data on such absorbance. FIG. 19 illustrates 14 pieces of time course data from data 1 to 14. FIG. 20 illustrates the data 1 to 14 arranged in order. In FIG. 19, as an example, one piece of time course data is obtained by measurement for 60 seconds at intervals of one second. That is, one piece of time course data includes 60 pieces of absorbance data. Hence, in FIG. 20, 60×14=840 pieces of data are arranged.

Here, in the example of FIG. 20, the data 1 to 12 is normal data, and the data 13 and 14 is abnormal data. The data and 14 includes an abnormality such that a distortion in a step shape occurs (frame lines illustrated in FIG. 19). The measuring operation is performed in a state in which the rotary table 501 and the chip holding unit 502 are stopped. However, a distortion in a step shape as described above may occur depending on mechanical conditions.

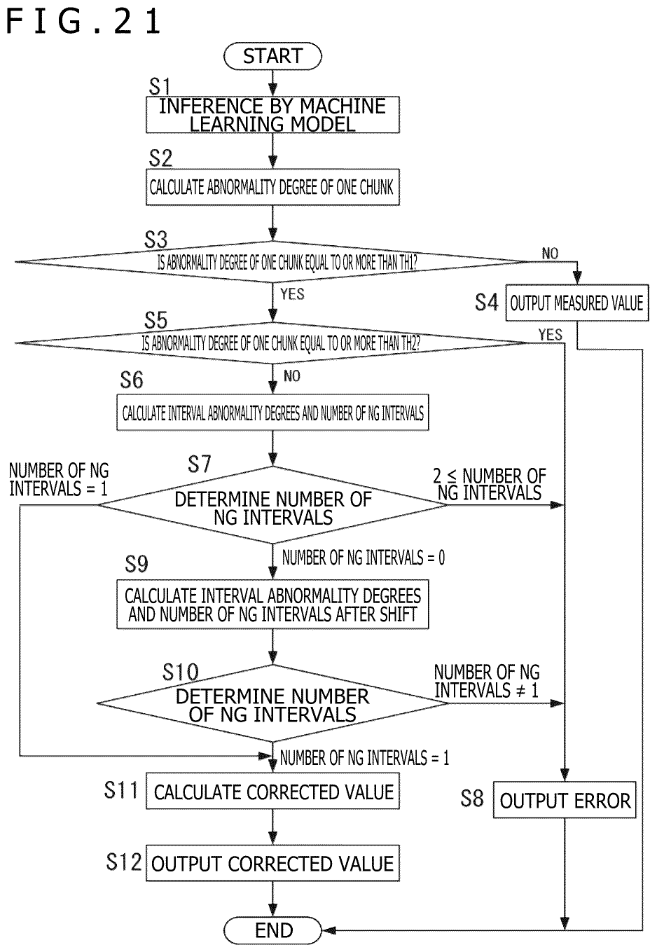

In order to detect such an abnormality, the biochemical analysis device 50 according to the present embodiment uses machine learning and the calculation of the abnormality degree. Abnormality detection processing in the biochemical analysis device 50 will be described along a flowchart illustrated in FIG. 21.

Here, a learning processing section 541 in the measurement control unit 54 performs learning (unsupervised learning) by a machine learning model using normal absorbance time course data in advance. Each piece of time course data is set as one chunk to be input to the machine learning model. In the example of FIG. 20, the data 1 to 9 is used for the learning. Thus, each piece of time course data from the data 1 to the data 9 forms one chunk. That is, the chunk width is 60.

Thereafter, each time new time course data is obtained, the processing illustrated in FIG. 21 is started. First, in step S1, an inference processing section 542 in the measurement control unit 54 performs inference by the machine learning model on the obtained time course data. In the example of FIG. 20, when the data 10 is obtained, for example, inference data (60 pieces of data) in a case where the data 10 is input to the machine learning model is obtained. Then, in step S2, an abnormality degree calculating section 543 in the measurement control unit 54 calculates the abnormality degree in the one chunk. For example, the abnormality degree is calculated on the basis of inference data obtained for the data 10 and the loss function.

The processing proceeds to step S3, where a determining section 544 in the measurement control unit 54 determines whether the abnormality degree obtained in step S2 is equal to or more than a threshold value TH1. When the abnormality degree is not equal to or more than the threshold value TH1, the processing proceeds to step S4, where the obtained time course data is output as a measured value as it is from an output section 545 in the measurement control unit 54.

When the abnormality degree is equal to or more than the threshold value TH1, on the other hand, the processing proceeds to step S5, where the determining section 544 determines whether the abnormality degree obtained in step S2 is equal to or more than a threshold value TH2 (>TH1). When the abnormality degree is equal to or more than the threshold value TH2, the output section 545 outputs an error.

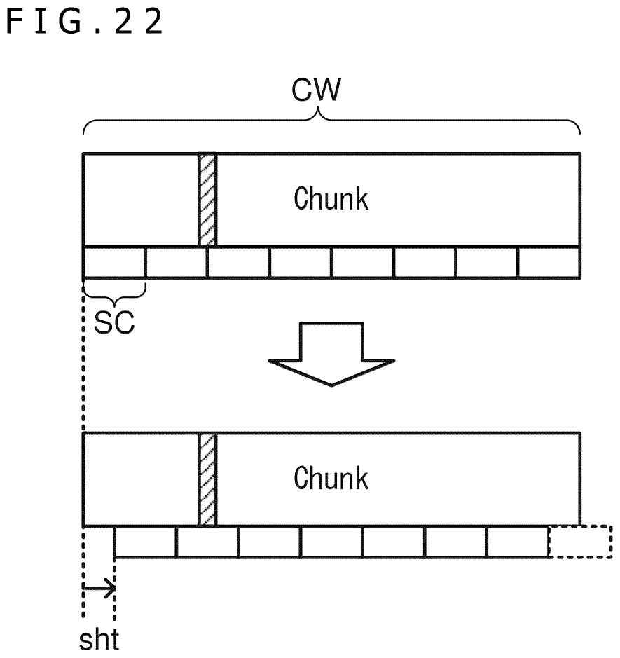

When the abnormality degree is not equal to or more than the threshold value TH2, the processing proceeds to step S6, where an interval abnormality degree calculating section 546 in the measurement control unit 54 calculates interval abnormality degrees. An interval abnormality degree is an abnormality degree in one interval obtained by dividing the chunk width into a plurality of intervals. However, here, as illustrated in a conceptual diagram of FIG. 22, the interval abnormality degree is calculated in a case where intervals SC are arranged from a start of the chunk width CW of the inference target chunk in step S1. For example, in a case where the data 10 is obtained, supposing that the interval width (number of pieces of data in one interval) is 5, for example, for the chunk width=60, the chunk width CW is divided into intervals whose number is Chunk Width/Interval Width=12.

In addition, in step S6, an interval count calculating section 547 in the measurement control unit 54 calculates, as the number of NG (No Good) intervals, the number of interval abnormality degrees equal to or more than a threshold value TH3 among the interval abnormality degrees calculated in step S6.

The processing proceeds to step S7, where the determining section 544 makes a determination for the number of the NG intervals. When the number of the NG intervals is equal to or more than two, the processing proceeds to step S8, where the output section 545 outputs an error. When the number of the NG intervals is 0, on the other hand, the processing proceeds to step S9. In step S9, the interval abnormality degree calculating section 546 calculates the interval abnormality degrees after a shift. As illustrated in FIG. 22, when the intervals SC are shifted by a shift amount sht, the intervals SC are arranged from a position shifted rearward by the shift amount sht from the start of the chunk width CW. Incidentally, as indicated by a broken line interval SC in FIG. 22, in a case where the interval SC is not contained in the chunk width CW after the shift, the interval SC that is not contained is not set.

In addition, in step S9, the interval count calculating section 547 calculates, as the number of NG intervals, the number of interval abnormality degrees equal to or more than the threshold value TH3 among the calculated interval abnormality degrees after the shift. The processing proceeds to step S10, where the determining section 544 makes a determination for the number of the NG intervals. When the number of the NG intervals is not 1, the processing proceeds to step S8, where the output section 545 outputs an error. When the number of the NG intervals is 1, on the other hand, the processing proceeds to step S11. Incidentally, the processing proceeds to step S11 also when the number of the NG intervals is 1 in step S7.

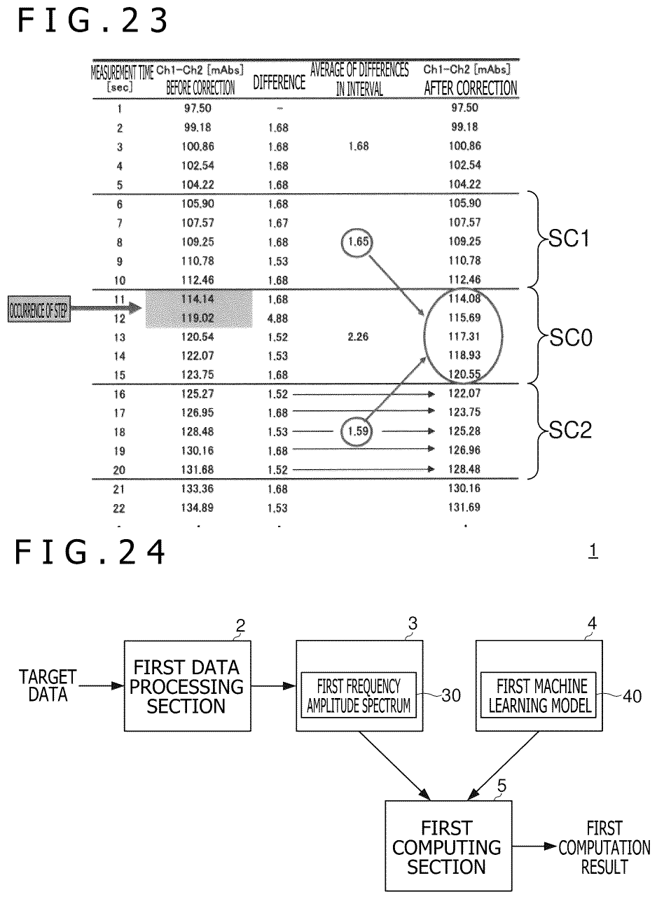

In step S11, a correcting section 548 in the measurement control unit 54 performs correction processing. The correction processing corrects absorbance data in one NG interval identified in step 7 or in step S10. The correction processing will be described with reference to FIG. 23. FIG. 23 illustrates an example of time course data, and illustrates, from a left side, measurement time, absorbance data before correction, differences (=differences between preceding and succeeding absorbance data before the correction), an average of differences in one interval, and absorbance data after the correction.

The correction processing calculates averages of respective differences (1.65 and 1.59) (average is 1.62) in respective intervals SC1 and SC2 preceding and succeeding one identified NG interval SC0. Then, absorbance data after the correction is generated by adding, for each measurement time, the above-described calculated average to the last absorbance data before the correction in the interval SC1 preceding the NG interval SC0. Then, in and after the interval SC2 succeeding the NG interval SC0, absorbance data after the correction is generated by adding, for each time, the differences of the data before the correction to the last absorbance data after the correction in the NG interval SC0.

The processing proceeds to step S12, where the output section 545 outputs the absorbance data after the correction. The processing is completed (ended) after step S4, S8, or S12.

According to such abnormality detection processing, in the example of FIG. 20, when each of the data 13 and the data 14 is obtained, it is possible to detect a distortion in a step shape by calculating the interval abnormality degree, and make the correction. This obviates a need for performing the measuring operation again.

### OTHERS

It is to be noted that various technical features disclosed in the present specification can be variously modified besides the foregoing embodiments without departing from the spirit of technical creation thereof. That is, the foregoing embodiments are to be considered illustrative and not restrictive in all respects, and it is to be understood that the technical scope of the present invention is not limited to the foregoing embodiments, but includes all modifications belonging within meanings and ranges equivalent to claims.

For example, in the foregoing embodiments, chunks are set two-dimensionally by the number of rows and the number of columns. However, chunks may be set in three dimensions or more.

In addition, for example, an abnormality detecting method according to the present disclosure is not limited to the foregoing embodiments, but is applicable to various kinds of industrial machinery devices, household electric devices, analytical devices, medical devices, and other devices.

### SUPPLEMENTARY NOTES

As described above, the abnormality detecting method according to one aspect of the present disclosure is an abnormality detecting method using a computing device (100A),
one cluster of data in a case where data is sequentially supplied to a machine learning model being referred to as a chunk,
the abnormality detecting method including
a step of obtaining a learning result by performing unsupervised learning by the machine learning model with a predetermined chunk width on a basis of first data,
a step of obtaining an inference result by performing inference by the machine learning model with the chunk width on a basis of second data and the learning result, and
a step of calculating an interval abnormality degree for each interval obtained by dividing the chunk width into a plurality of intervals on a basis of the second data and the inference result (first configuration).

According to such a configuration, accurate detection of an abnormality can be performed by generating the interval abnormality degree.

In the foregoing first configuration, a configuration may be adopted which includes a step of calculating an abnormality degree for each chunk width on a basis of the second data and the inference result (second configuration).

In addition, in the foregoing first or second configuration, a configuration may be adopted which includes a step of calculating the interval abnormality degree for each interval in a state in which the plurality of intervals are shifted by a set shift amount (third configuration).

In addition, in one of the foregoing first to third configurations, a configuration may be adopted in which the first data and the second data are data after frequency analysis processing (fourth configuration).

In addition, one aspect of the present disclosure is a computing device used for the abnormality detecting method according to one of the foregoing first to fourth configurations (fifth configuration).

In addition, one aspect of the present disclosure is a program (P) used for the abnormality detecting method according to one of the foregoing first to fourth configurations (sixth configuration).

In addition, one aspect of the present disclosure is a correcting method for correcting abnormal data detected by the abnormality detecting method according to one of the foregoing first to fourth configurations (seventh configuration).

In addition, an abnormality degree generating device (50) according to one aspect of the present disclosure includes
one cluster of data in a case where data is sequentially supplied to a machine learning model being referred to as a chunk,
a learning processing section (541) configured to obtain a learning result by performing unsupervised learning by the machine learning model with a predetermined chunk width on a basis of first data,
an inference processing section (542) configured to obtain an inference result by performing inference by the machine learning model with the chunk width on a basis of second data and the learning result, and
an interval abnormality degree calculating section (546) configured to calculate an interval abnormality degree for each interval obtained by dividing the chunk width into a plurality of intervals on a basis of the second data and the inference result (eighth configuration).

In addition, in the foregoing eighth configuration, a configuration may be adopted in which the first data and the second data are temporal change data of a measurement target, and the configuration includes a correcting section (548) configured to correct data in an interval in which an abnormality is detected on a basis of the interval abnormality degree (ninth configuration).

In addition, a configuration may be adopted in which the abnormality degree generating device according to the foregoing ninth configuration is a biochemical analysis device, and the temporal change data of the measurement target is absorbance data of a test liquid (tenth configuration).

### Second Disclosed Technology

The second disclosed technology will next be described.

### <Configuration of Machine Learning Device According to First Embodiment>

FIG. 24 is a diagram illustrating a configuration of a machine learning device 1 according to an illustrative first embodiment of the present disclosure. The machine learning device 1 includes a first data processing section 2, a data storage section 3, a model retaining section 4, and a first computing section 5.

The first data processing section 2 generates first sampling data by being directly supplied with target data and sampling the target data, and converts the first sampling data into a first frequency amplitude spectrum 30. The target data is time series analog data. The target data is, for example, output from a sensor such as an analog output sensor included in a machine system, and is supplied to the first data processing section 2. The conversion from the first sampling data to the first frequency amplitude spectrum is implemented by, for example, an FFT, a wavelet transform, or other transforms. In the conversion from the first sampling data to the first frequency amplitude spectrum, the conversion to the first frequency amplitude spectrum may be performed after processing such as normalization processing, envelope processing, and window function processing is performed on the first sampling data.

Incidentally, a digital output sensor, for example, may assume a part of the machine learning device 1, more specifically a part of the first data processing section 2 which part generates the first sampling data by being directly supplied with the target data and sampling the target data. In this case, the computer 100 and the digital output sensor constitute the machine learning device 1.

The data storage section 3 stores the first frequency amplitude spectrum 30 received from the first data processing section 2.

The model retaining section 4 retains a first machine learning model 40. The first machine learning model 40 is, for example, configured as a part of the simulation program P by MATLAB/Simulink (registered trademark). A concrete example of the first machine learning model 40 will be described later.

The first computing section 5 performs generally-called unsupervised learning and inference by using the first frequency amplitude spectrum 30 and the first machine learning model 40. The first computing section 5 performs the unsupervised learning by inputting the first frequency amplitude spectrum 30 as a learning target to the first machine learning model 40, and calculates a first computation result (for example, the abnormality degree). The first computing section 5 performs inference by inputting the first frequency amplitude spectrum 30 as an inference target to the first machine learning model 40, and calculates a first computation result (for example, the abnormality degree). The inference can be performed at a time of the above-described learning by the first computing section 5 and after completion of the learning.

Incidentally, while the first computing section 5 performs the learning and the inference by inputting the first frequency amplitude spectrum 30 to the first machine learning model 40 in the present embodiment, the first computing section 5 may perform only one of the learning and the inference.

### <Configuration of Machine Learning Model>

The first machine learning model 40 performs learning and inference on input data (first frequency amplitude as spectrum 30). A three-layer neural network 10a illustrated in FIG. 4, for example, is used as the first machine learning model 40.

As illustrated in FIG. 4, the three-layer neural network 10 is an AI model including an input layer 10A, a hidden layer 10B, and an output layer 10C. In general, in the three-layer neural network 10, for n-dimensional input data x∈R^{k×n} of a batch size k, an n′-dimensional inference result y∈R^{k×n′} is obtained as y=G (x·α+b)β. Here, α∈R^{n×m} is a weight connecting the input layer 10A and the hidden layer 10B to each other, and β∈R^{m×n′} is a weight connecting the hidden layer 10B and the output layer 10C to each other. In addition, b∈R^{m} is a bias of the hidden layer 10B, and G is an activation function of the hidden layer 10B.

The present embodiment uses an algorithm that can sequentially learn the three-layer neural network 10 with an arbitrary batch size. In a case where ith learning data {xᵢ∈R^{ki×n}, tᵢ∈R^{ki×n′}} of a batch size kᵢ is obtained, βᵢ that minimizes an error illustrated in the following Equation (1) needs to be obtained.

$$\begin{matrix}[ Math . 5 ] & \\ ‖ [ \begin{matrix}{H}_{0} \\ ⋮ \\ {H}_{i}\end{matrix} ] {β}_{i} - [ \begin{matrix}{t}_{0} \\ ⋮ \\ {t}_{i}\end{matrix} ] ‖ & ( 1 )\end{matrix}$$

Incidentally, an ith hidden layer matrix Hᵢ=G(xᵢ·α+b). In addition, t is teacher data corresponding to the inference result y.

An optimized weight βᵢ is calculated by the following Equation (2).

$${P}_{i} = {P}_{i - 1} - {P}_{i - 1} {{H}_{i}^{T} ( I + {H}_{i} {P}_{i - 1} {H}_{i}^{T} )}^{- 1} {H}_{i} {P}_{i - 1} \qquad ( 2 )$$

$${β}_{i} = {β}_{i - 1} - {P}_{i} {H}_{i}^{T} ( {t}_{i} - {H}_{i} {β}_{i - 1} )$$

Here, P₀ and β₀ are obtained by the following Equation (3).

$${P}_{0} = {( {H}_{0}^{T} {H}_{0} )}^{- 1} \qquad ( 3 )$$

$${β}_{0} = {P}_{0} {H}_{0}^{T} {t}_{0}$$

The learning algorithm is as follows.

The values of the weight α and the bias b are initialized by random numbers.

H₀ for x₀ is calculated, and P₀ and β₀ are calculated.

Pᵢ and βᵢ are sequentially calculated each time the ith learning data of the batch size kᵢ is obtained. Incidentally, a value initialized by a random number may be set as β₀ without the use of the calculation equation of β₀ in Equation (3).

In addition, the present embodiment performs learning using an autoencoder. The autoencoder uses input data as teacher data as it is, and performs learning so as to be able to reconstruct the input data as an inference result. That is, in the case of the above description, learning is performed with t=x. The autoencoder does not necessitate the generation of separate teacher data, and is therefore a kind of unsupervised learning algorithm.

According to such a first machine learning model 40, learning can be performed by a computing device such as a microcomputer in an edge device. Incidentally, the edge device refers to an information processing device that inherits a learned machine learning model from another device, and performs inference computation by using the learned machine learning model. That is, when such on-device learning is introduced into, for example, the detection of an abnormality in a motor or other detection, an effect of the abnormality detection can be confirmed by simulation. The edge device is an example of an electronic apparatus including the machine learning device.

The first machine learning model 40 calculates an abnormality degree by a loss function L(y, t) representing an error between the inference result y and the teacher data t. MAE or MSE, for example, is used as the loss function. In a case where the loss function is MAE, the loss function L is expressed as in the following Equation (4).

$$\begin{matrix}[ Math . 6 ] & \\ L ( y , x ) = \frac{1}{{n}^{′}} \sum \vert y - x \vert & ( 4 )\end{matrix}$$

In addition, in a case where the loss function is MSE, the loss function L is expressed as in the following Equation (5).

$$\begin{matrix}[ Math . 7 ] & \\ L ( y , x ) = \frac{1}{{n}^{′}} \sum {\vert y - x \vert}^{2} & ( 5 )\end{matrix}$$

Because learning is performed by using the autoencoder, the abnormality degree is calculated with the loss function L(y, t)=L(y, x).

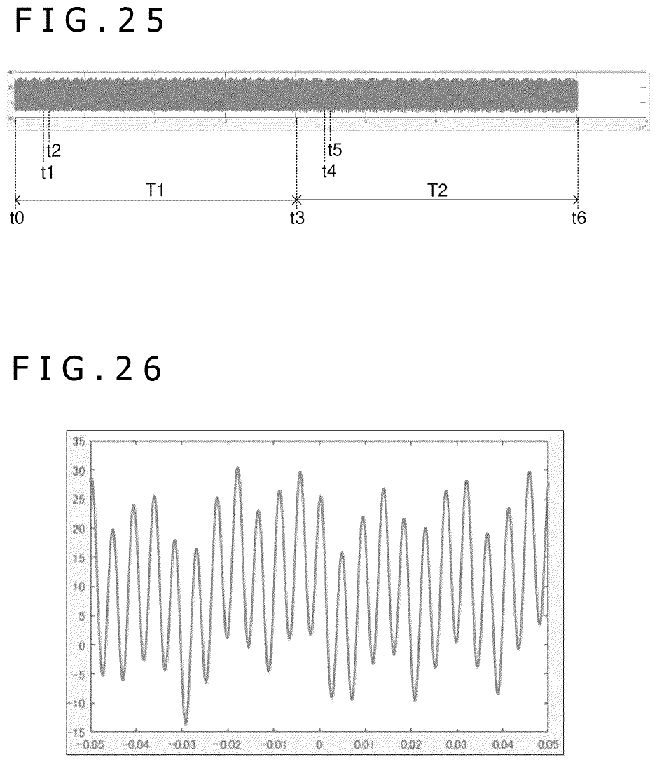

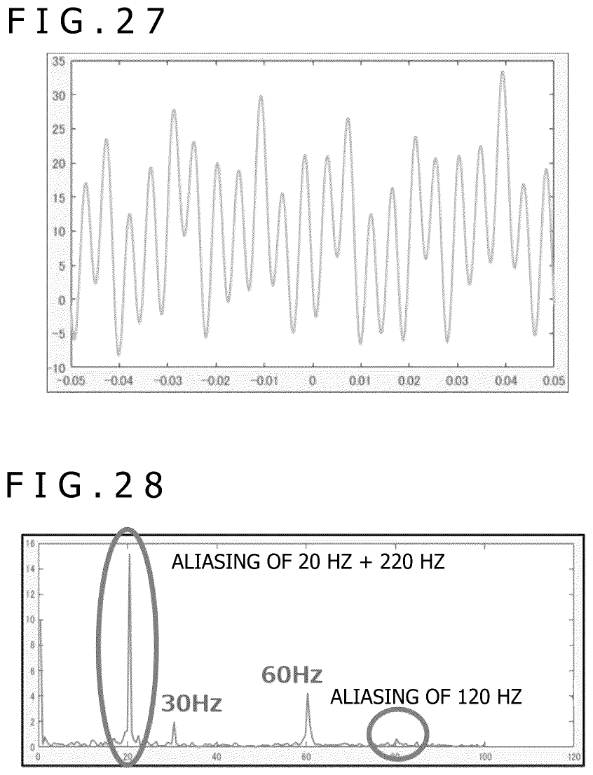

FIG. 25 is a graph illustrating an example of the target data. FIG. 25 illustrates the target data in a time series graph with an axis of abscissas indicating time and with an axis of ordinates indicating a predetermined output value. FIG. 26 is a graph illustrating, on an enlarged scale, a part from time t1 to time t2 in FIG. 25. FIG. 27 is a graph illustrating, on an enlarged scale, a part from time t4 to time t5 in FIG. 25.

In FIG. 25, a start point of the data is set as time to, and an end point of the data is set as time t6. In addition, in FIG. 25, a period from time t0 to time t3 is set as a normal period T1. In addition, in FIG. 25, a period from time t3 to time t6 is set as an abnormal period T2.

The normal period T1 is a period in which no abnormality occurs in the target data. That is, the normal period T1 is a period in which no particular abnormality is estimated to occur in an output value of a machine system in which the machine learning device 6 is implemented. On the other hand, the abnormal period T2 is a period in which an abnormality occurs in the target data. That is, the abnormal period T2 is a period in which some abnormality is estimated to occur in the output value of the machine system in which the machine learning device 6 is implemented.

In the example illustrated in FIGS. 25 to 27, the target data includes a 20-Hz component, a 30-Hz component, a 60-Hz component, a 120-Hz component, and a 220-Hz component. In addition, in the example illustrated in FIGS. 25 to 27, the 220-Hz component and the 120-Hz component of the target data in the abnormal period T2 are large as compared with the target data in the normal period T1. That is, in the example illustrated in FIGS. 25 to 27, an abnormal state appears in the 220-Hz component and the 120-Hz component of the target data.

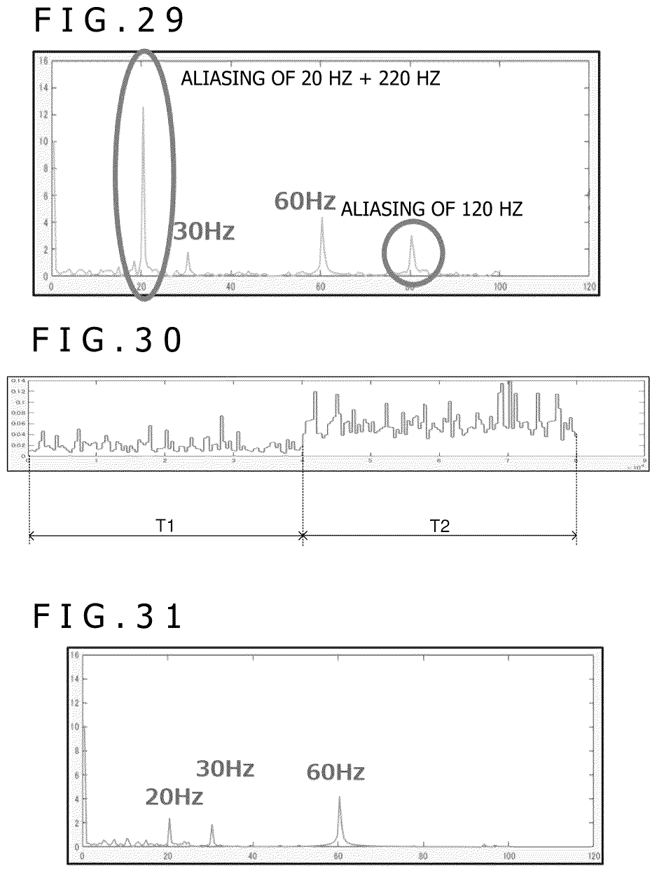

Here, in a case where a sampling frequency in the first data processing section 2 is 200 Hz, high-frequency components of a Nyquist frequency of 100 Hz (=200 Hz/2) and higher are folded back to a band equal to or lower than the Nyquist frequency due to aliasing. Hence, the first frequency amplitude spectrum 30 corresponding to FIG. 26 is as illustrated in FIG. 28, and the first frequency amplitude spectrum 30 corresponding to FIG. 27 is as illustrated in FIG. 29.

As is understood from FIG. 28 and FIG. 29, the first frequency amplitude spectrum 30 corresponding to FIG. 26 (first frequency amplitude spectrum 30 in the normal period T1) and the first frequency amplitude spectrum 30 corresponding to FIG. 27 (first frequency amplitude spectrum 30 in the abnormal period T2) have waveforms different from each other. Thus, the abnormality degree in the normal period T1 and the abnormality degree in the abnormal period T2 can be distinguished from each other as illustrated in FIG. 30. The machine learning device 1 can therefore detect an abnormality even when an abnormal state appears in a high frequency region of the target data (region equal to or higher than the Nyquist frequency).

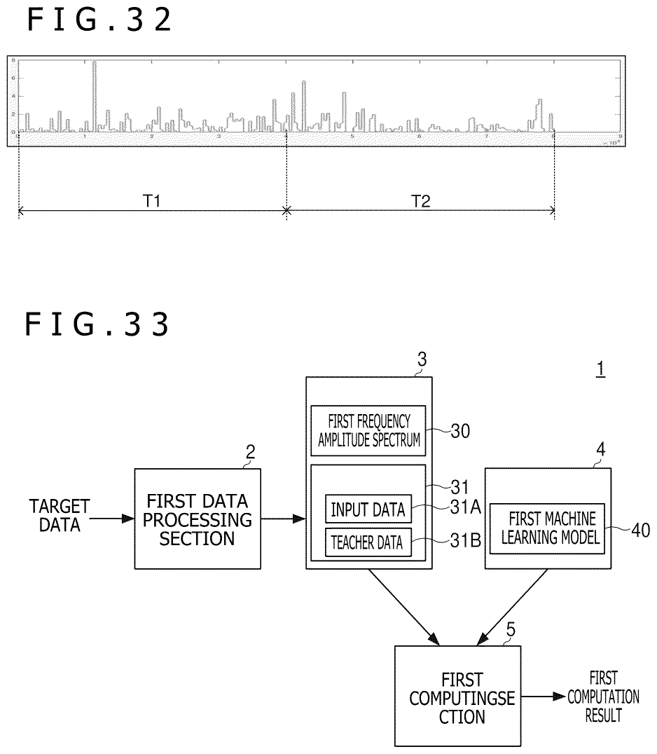

Here, if an antialiasing filter that removes the frequency components of the Nyquist frequency and higher is provided to suppress aliasing, the first frequency amplitude spectrum 30 corresponding to FIG. 26 and the first frequency amplitude spectrum 30 corresponding to FIG. 27 are both as illustrated in FIG. 31. Thus, the abnormality degree in the normal period T1 and the abnormality degree in the abnormal period T2 may not be distinguished from each other, as illustrated in FIG. 32. Consequently, if the first data processing section 2 is provided with the antialiasing filter, the machine learning device 1 may not detect an abnormality when an abnormal state appears in the high frequency region of the target data (region equal to or higher than the Nyquist frequency).

### <Configuration of Machine Learning Device According to Second Embodiment>

FIG. 33 is a diagram illustrating a configuration of a machine learning device 1 according to an illustrative second embodiment of the present disclosure. The machine learning device 1 includes a first data processing section 2, a data storage section 3, a model retaining section 4, and a first computing section 5. In the following, description of parts similar to those of the first embodiment will be omitted as appropriate.

The data storage section 3 stores learning data 31. The learning data 31 includes input data 31A and teacher data (Training data) 31B. The learning data 31 is data for performing generally-called supervised learning by respectively supplying the input data 31A and the teacher data 31B as input and output to the first machine learning model 40.

The first computing section 5 performs supervised learning and inference by using the first frequency amplitude spectrum 30 and the first machine learning model 40. The first computing section 5 performs the supervised learning by supplying the input data 31A as input to the first machine learning model 40 and supplying the teacher data (Training data) 31B as output to the first machine learning model 40. The first frequency amplitude spectrum 30 as a learning target is used as the input data (Input data) 31A. The first computing section 5 performs inference by inputting the first frequency amplitude spectrum 30 as an inference target to the first machine learning model 40. The inference can be performed at a time of the above-described learning by the first computing section 5 and after completion of the learning.

Incidentally, while the first computing section 5 performs the learning and the inference by inputting the first frequency amplitude spectrum 30 to the first machine learning model 40 in the present embodiment, the first computing section 5 may perform only one of the learning and the inference.

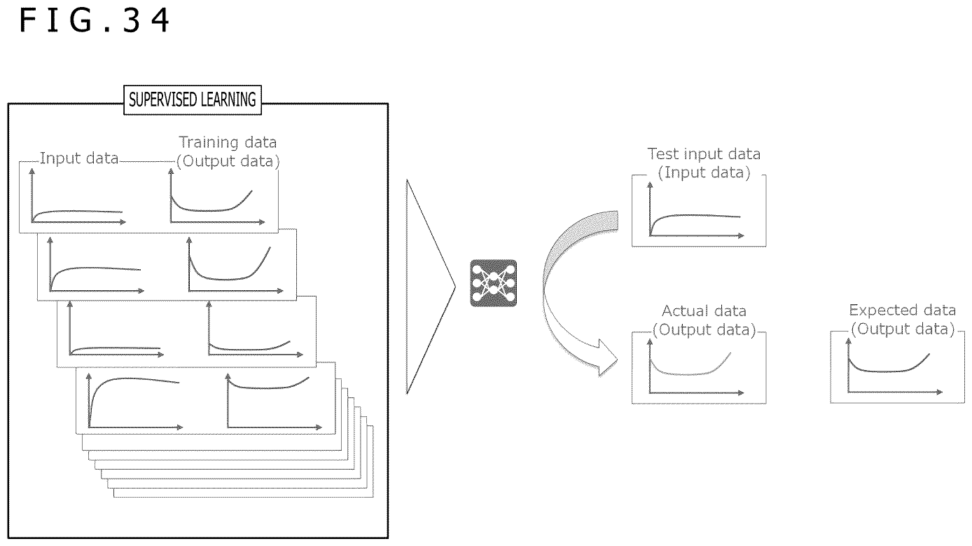

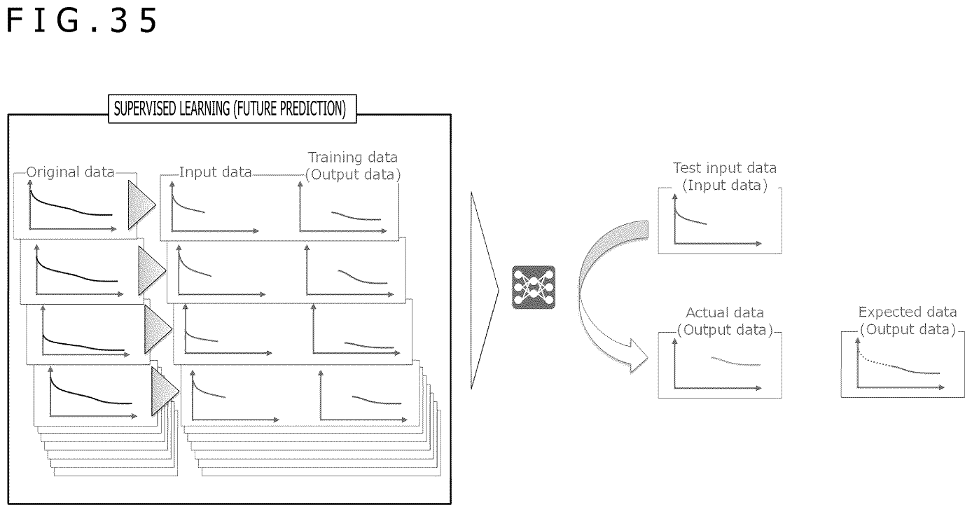

Here, an outline of the supervised learning will be described. FIG. 34 is a diagram of assistance in explaining the supervised learning. In the supervised learning, the machine learning model (AI) is provided with the input data (Input data) as input and the teacher data (Training data) as output, and parameters of the machine learning model are learned. Thereafter, test input data is input to the machine learning model, and inference data is output as a result of inference by the machine learning model. The output inference data is compared with expected data (Expected data). Incidentally, in FIG. 34 and FIG. 35, the inference data is illustrated as a target of comparison with the expected data, that is, as actual data.

FIG. 35 is a diagram of assistance in explaining future prediction as an example of a task of the supervised learning. In this case, original data is divided into input data as a first half in a time series and teacher data as a second half. Then, learning by the machine learning model is performed by using the input data and the teacher data. Thereafter, when test input data as a first half in the time series is input to the machine learning model, actual data as a second half in the time series (inference data) is output from the machine learning model. Thus, the data of the second half can be predicted on the basis of the data of the first half in the time series. The output actual data is compared with the expected data.

### <Configuration of Machine Learning Device According to Third Embodiment>

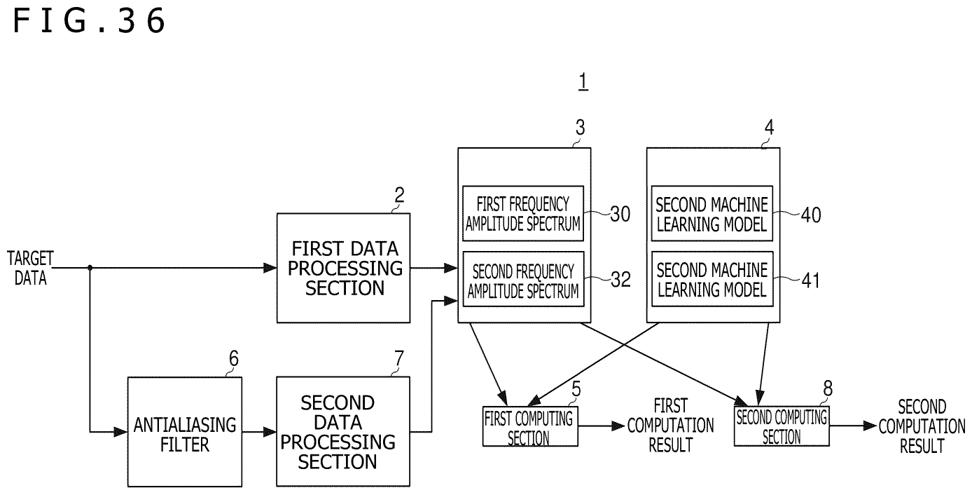

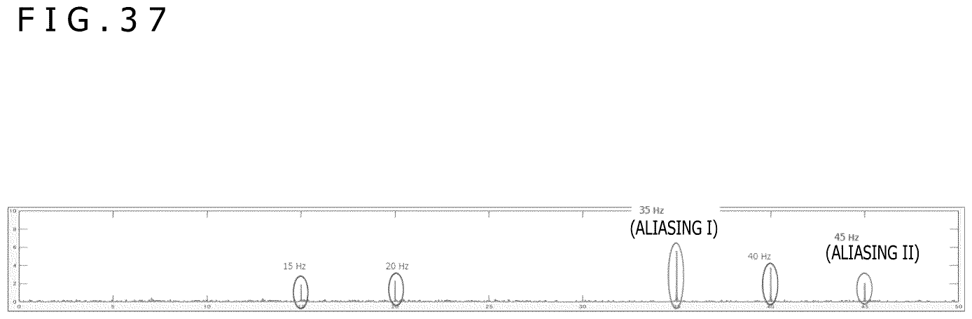

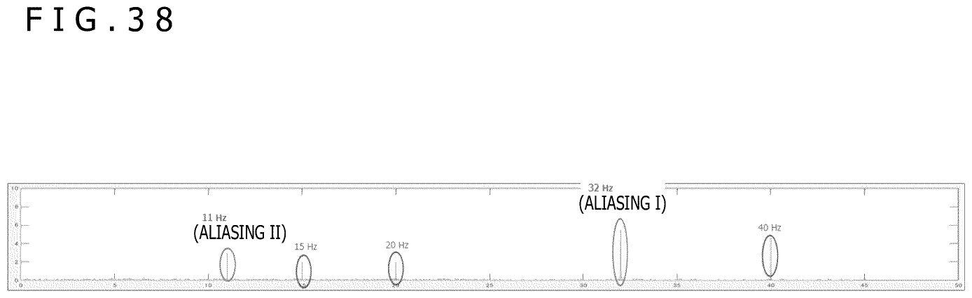

FIG. 36 is a diagram illustrating a configuration of a machine learning device 1 according to an illustrative third embodiment of the present disclosure. The third embodiment is a modification of the first embodiment. In the first embodiment, in a case where an abnormal state appears in a low frequency region of the target data (region equal to or lower than the Nyquist frequency), it may be difficult to detect an abnormality when high frequency noise or other noise included in the target data is folded back to a band equal to or lower than the Nyquist frequency due to aliasing.

The machine learning device 1 according to the illustrative third embodiment of the present disclosure is configured to be able to detect an abnormality even when an abnormal state appears in a high frequency region of the target data (region equal to or higher than the Nyquist frequency), and easily detect an abnormality when an abnormal state appears in a low frequency region of the target data (region equal to or lower than the Nyquist frequency).

The machine learning device 1 includes a first data processing section 2, a data storage section 3, a model retaining section 4, a first computing section 5, an antialiasing filter 6, a second data processing section 7, and a second computing section 8. In the following, description of parts similar to those of the first embodiment is omitted as appropriate.

The model retaining section 4 also retains a second machine learning model 41. The second machine learning model 41 is, for example, configured as a part of the simulation program P by MATLAB/Simulink (registered trademark). A concrete example of the second machine learning model 41 is, for example, similar to a concrete example of the first machine learning model 40.

The antialiasing filter 6 is provided in a stage preceding the second data processing section 7. Used as the antialiasing filter 6 is, for example, a band-pass filter, a Butterworth low-pass filter, a Chebyshev low-pass filter, elliptic function low-pass filter, or other filters.

The second data processing section 7 generates second sampling data by sampling the target data via the antialiasing filter 6, and converts the second sampling data into a second frequency amplitude spectrum 32. That is, the target data is input to the antialiasing filter 6, and output of the antialiasing filter 6 is supplied to the second data processing section 7. The second data processing section 7 generates the second sampling data by sampling the output of the antialiasing filter 6.

The second computing section 8 performs generally-called unsupervised learning and inference by using the second frequency amplitude spectrum 32 and the second machine learning model 41. The second computing section 8 performs the unsupervised learning by inputting the second frequency amplitude spectrum 32 as a learning target to the second machine learning model 41, and calculates a second computation result (for example, the abnormality degree). The second computing section 8 performs: inference by inputting the second frequency amplitude spectrum 32 as an inference target to the second machine learning model 41, and calculates a second computation result (for example, the abnormality degree). The inference can be performed at a time of the above-described learning by the second computing section 8 and after completion of the learning.

In the second frequency amplitude spectrum 32, the high frequency region of the target data (region equal to or higher than the Nyquist frequency) is not folded back to the band equal to or lower than the Nyquist frequency. Therefore, in a case where an abnormal state appears in the low frequency region of the target data (region equal to or lower than the Nyquist frequency), an abnormality can be detected easily on the basis of the second computation result (for example, the abnormality degree).

The processing of the first computing section 5 and the processing of the second computing section 8 may be performed in parallel with each other, or may be performed after order of priority is determined.

In a case where the processing of the first computing section 5 and the processing of the second computing section 8 are performed in parallel with each other, it is possible to determine on the basis of a combination of the first computation result (for example, the abnormality degree) and the second computation result (for example, the abnormality degree) whether there is normality, whether a first abnormality has occurred such that an abnormal state appears in the high frequency region of the target data (region equal to or higher than the Nyquist frequency), whether a second abnormality has occurred such that an abnormal state appears in the low frequency region of the target data (region equal to or lower than the Nyquist frequency), or whether both of the first abnormality and the second abnormality have occurred.

In a case where the order of priority of the processing of the first computing section 5 and the processing of the second computing section 8 is determined, and then the processing of the first computing section 5 and the processing of the second computing section 8 are performed, for example, whether or not the first abnormality has occurred is first determined on the basis of the first computation result (for example, the abnormality degree), and when the first abnormality has not occurred, whether there is normality or whether or not the second abnormality has occurred is next determined on the basis of the second computation result (for example, the abnormality degree).

Incidentally, a modification similar to the modification from the first embodiment to the present embodiment may be performed on the second embodiment.

<Configuration of Machine Learning Device according to Fourth Embodiment>

A fourth embodiment is different from the first embodiment in that the first data processing section 2 generates two kinds of first sampling data by sampling the target data at two kinds of sampling frequencies, converts a first kind of first sampling data into a first kind of first frequency amplitude spectrum 30, and converts a second kind of first sampling data into a second kind of first frequency amplitude spectrum 30. The fourth embodiment is otherwise similar to the first embodiment. The first data processing section 2 includes two Analog to Digital Converters (ADCs) in order to be able to sample the target data at the two kinds of sampling frequencies.

A frequency position at which the high-frequency components of the Nyquist frequency and higher are folded back to the band equal to or lower than the Nyquist frequency due to aliasing changes according to sampling frequency. Thus, when there is a peak of an original frequency component at the folding-back position, for example, the use of the two kinds of sampling frequencies can prevent the folding-back position and the original frequency component from coinciding with each other at one of the sampling frequencies. Hence, an improvement in accuracy of abnormality detection can be expected in a case where an abnormal state appears in the high frequency region of the target data.

For example, in a case where the target data includes a 15-Hz component, a 20-Hz component, a 40-Hz component, a 235-Hz component, and a 345-Hz component, and the two kinds of sampling frequencies are 100 Hz and 89 Hz, the narrowing down of approximate original frequency bands of aliasing is as follows.

FIG. 37 is a diagram illustrating a first frequency amplitude spectrum 30 in a case of a sampling frequency of 100 Hz. FIG. 38 is a diagram illustrating a first frequency amplitude spectrum 30 in a case of a sampling frequency of 89 Hz.

As is understood from FIG. 37 and FIG. 38, the 15-Hz component, the 20-Hz component, and the 40-Hz component have peaks appearing in same frequency bands and with same amplitudes in the case of the sampling frequency of 100 Hz and in the case of the sampling frequency of 89 Hz.

As for the peak of a 35-Hz component in the case of the sampling frequency of 100 Hz (see FIG. 37) and the peak of a 32-Hz component in the case of the sampling frequency of 89 Hz (see FIG. 38), high frequencies in same frequency bands in terms of an amplitude value are folded back and appear due to aliasing (aliasing I).

As for the peak of a 45-Hz component in the case of the sampling frequency of 100 Hz (see FIG. 37) and the peak of an 11-Hz component in the case of the sampling frequency of 89 Hz (see FIG. 38), high frequencies in same frequency bands in terms of an amplitude value are folded back and appear due to aliasing (aliasing II).

With regard to the aliasing I, in the case of the sampling frequency of 100 Hz, high frequencies that cause a peak to appear in the frequency band of 35 Hz due to aliasing are 65 Hz, 135 Hz, 165 Hz, 235 Hz, . . . , that is, multiples of 100±35 Hz.

With regard to the aliasing I, in the case of the sampling frequency of 89 Hz, high frequencies that cause a peak to appear in the frequency band of 32 Hz due to aliasing are 57 Hz, 121 Hz, 146 Hz, 210 Hz, . . . , that is, multiples of 89±32 Hz.

The original frequency bands of aliasing that satisfy the above-described two conditions are multiples of 8900±235 Hz and multiples of 8900±2435 Hz. That is, the original frequency bands of aliasing can be narrowed down. Incidentally, 8900 is a least common multiple of 100 and 89.

With regard to the aliasing II, in the case of the sampling frequency of 100 Hz, high frequencies that cause a peak to appear in the frequency band of 45 Hz due to aliasing are 55 Hz, 145 Hz, 155 Hz, 245 Hz, . . . , that is, multiples of 100±45 Hz.

With regard to the aliasing II, in the case of the sampling frequency of 89 Hz, high frequencies that cause a peak to appear in the frequency band of 11 Hz due to aliasing are 78 Hz, 100 Hz, 167 Hz, 189 Hz, . . . , that is, multiples of 89±11 Hz.

The original frequency bands of aliasing that satisfy the above-described two conditions are multiples of 8900±345 Hz and multiples of 8900±545 Hz. That is, the original frequency bands of aliasing can be narrowed down.

Here, the two kinds of sampling frequencies are preferably relatively prime. When the two kinds of sampling frequencies are relatively prime, the narrowing down of the approximate original frequency bands of aliasing can be optimized.

Incidentally, a modification similar to the modification from the first embodiment to the present embodiment may be performed on the second embodiment. In addition, while the first data processing section 2 samples the target data at the two kinds of sampling frequencies in the present embodiment, the first data processing section 2 may sample the target data at three kinds or more of sampling frequencies.

### OTHERS

It is to be considered that the foregoing embodiment is illustrative in all respects, and is not restrictive. It is to be understood that the technical scope of the present disclosure is represented by claims rather than the description of the foregoing embodiment, and includes all changes belonging to meanings and a scope equivalent to the claims.

For example, the third embodiment and the fourth embodiment may be combined with each other and carried out.

### SUPPLEMENTARY NOTES

Supplementary notes will be provided to the present disclosure whose concrete configuration example has been illustrated in the embodiment described earlier.

A machine learning device (1) according to the present disclosure has a configuration including a model retaining section (4) configured to retain a first machine learning model (40), a first data processing section (2) configured to generate first sampling data by being directly supplied with target data and sampling the target data, and convert the first sampling data into a first frequency amplitude spectrum (30), and a first computing section (5) configured to perform at least one of learning and inference by inputting the first frequency amplitude spectrum to the first machine learning model, and calculate a first computation result (first configuration).

The machine learning device according to the foregoing first configuration is directly supplied with the target data and samples the target data, and therefore folds back high-frequency components of the Nyquist frequency and higher to the band equal to or lower than the Nyquist frequency by aliasing. The machine learning device according to the foregoing first configuration inputs the first frequency amplitude spectrum including the high-frequency components folded back by aliasing to the first machine learning model, and can therefore detect an abnormality even when an abnormal state appears in the high frequency region of the target data.

In the machine learning device according to the foregoing first configuration, a configuration may be adopted in which the first data processing section is configured to sample the target data at two or more kinds of sampling frequencies (second configuration).

In the machine learning device according to the foregoing second configuration, a configuration may be adopted in which the two or more kinds of sampling frequencies are each relatively prime (third configuration).

In the machine learning device according to one of the foregoing first to third configurations, a configuration may be adopted in which the machine learning device further includes a second data processing section (7) and a second computing section (8), in which the model retaining section is configured to retain also a second machine learning model, the second data processing section is configured to generate second sampling data by sampling the target data via an antialiasing filter (6), and convert the second sampling data into a second frequency amplitude spectrum (32), and the second computing section is configured to perform at least one of learning and inference by inputting the second frequency amplitude spectrum to the second machine learning model, and calculate a second computation result (fourth configuration).

An electronic apparatus according to the present disclosure includes the machine learning device according to one of the foregoing first to fourth configurations.

A program according to the present disclosure is a program for making a computer perform a first step of generating first sampling data by being directly supplied with target data and sampling the target data, and converting the first sampling data into a first frequency amplitude spectrum, and a second step of performing at least one of learning and inference by inputting the first frequency amplitude spectrum to a first machine learning model, and calculating a first computation result.

A simulation device according to the present disclosure is configured to calculate the first computation result by using the machine learning device according to one of the foregoing first to fourth configurations.

A data processing method according to the present disclosure includes a first step of generating first sampling data by being directly supplied with target data and sampling the target data, and converting the first sampling data into a first frequency amplitude spectrum; and a second step of performing at least one of learning and inference by inputting the first frequency amplitude spectrum to a first machine learning model, and calculating a first computation result.

### Third Disclosed Technology

The third disclosed technology will next be described.

### <Basic Configuration of Machine Learning Device 6>

A basic configuration of the machine learning device 6 will next be described. The machine learning device 6 is constituted by an MCU. The machine learning device 6 is incorporated into a predetermined machine system (motor device or other devices), and performs control of this machine system. In addition to the control of the machine system, the machine learning device 6 can also perform machine learning using various data of the machine system as input data.

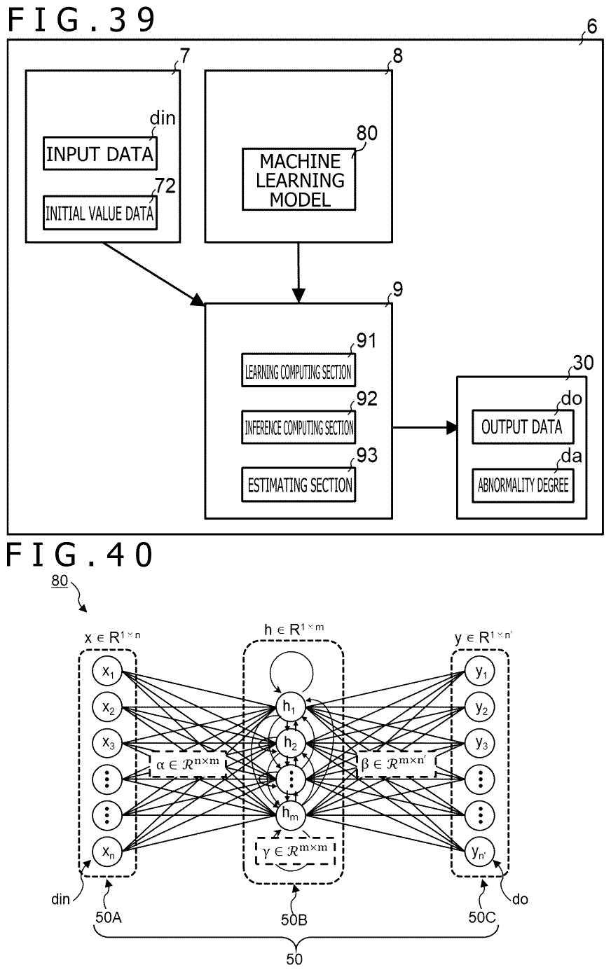

FIG. 39 is a block diagram illustrating a basic configuration of the machine learning device 6. As illustrated in FIG. 39, the machine learning device 6 includes a data storage section 7, a model retaining section 8, and a computing section 9.

The data storage section 7 stores input data din and initial value data 72. The input data din is, for example, time series data output from the machine system (motor device or devices) or other system. The time series data may be subjected to preprocessing such as normalization processing or an FFT as needed. Initial values determined in the computer 100 as described above are set as the initial value data 72.

The model retaining section 8 retains a machine learning model 80. The machine learning model 80 is a machine learning model capable of learning and inference according to the input data din. Details of the machine learning model 80 will be described later.

The computing section 9 calculates a computation result 30 by using the input data din and the machine learning model 80. The computation result 30 includes an inference result (output data do to be described later) of an inference computing section 92, an estimation result (for example, an abnormality degree da to be described later) of an estimating section 93, and other results. The computing section 9 will be concretely described as follows.

The computing section 9 includes a learning computing section 91, an inference computing section 92, and an estimating section 93. The learning computing section 91 performs learning by using the machine learning model 80, the input data din, and the initial value data 72. This learning can be either of supervised learning and unsupervised learning.

The inference computing section 92 performs inference by using the machine learning model 80, the input data din, and the initial value data 72, and generates output data do. This inference may be performed at either of a time during the above-described learning by the learning computing section 91 and a time after completion of the learning.

The output data do is a result of the inference by inputting the input data din to the machine learning model 80 after the learning. In a case where the learning is performed on the basis of normal input data din, the output data do indicates a normal state. That is, in this case, the machine learning model 80 generates the output data do approximate to the normal input data din.

Suppose that a part of the input data din which part is not learned includes an abnormal state. In this case, a deviation occurs between the output data do and the actual input data din in the part not learned.

The estimating section 93 performs a predetermined estimation on the basis of the input data din and the output data do generated by the inference computing section 92. This estimation, for example, detects the presence or absence of an abnormality in the input data din, calculates an abnormality degree da, and makes a future prediction of the input data din. The estimating section 93 includes an estimation result of the above-described estimation (abnormality degree da in FIG. 39) in the computation result 30. That is, when the computing section 9 generates the computation result 30, the computation result 30 includes the estimation result of the estimating section 93 in a predetermined form.

<Abnormality Degree da>

In the following, the abnormality degree da will be described as an example of the estimation result generated by the estimating section 93. The abnormality degree da is a numerical value indicating a degree of an abnormality possessed by the output data do. The abnormality degree da in a case where input data 71 does not include an abnormal state and the abnormality degree da in a case where the input data 71 includes an abnormal state are different from each other in terms of a mode, a tendency, or other states. That is, a shift in the mode, tendency, or other states indicates an abnormality of the input data 71.

An input/output error, for example, can be adopted as the abnormality degree da. The input/output error is an error between a value included in an input layer 50A (=the input data din) and a value included in an output layer 50C (=the output data do) when inference is performed by inputting the input data din to the machine learning model 80. The input/output error is calculated by a loss function. The loss function for calculating the abnormality degree da will be described later.

In a case where a deviation occurs between the input data 71 and the output data do as described above, the mode, tendency, or other states of the input/output error (=the abnormality degree da) changes as compared with a case where the deviation does not occur.

Incidentally, the abnormality degree da may adopt a computation result of a function of other than the input/output error, or may include the input/output error and a plurality of other computation results. In addition, at this time, in a case where the abnormality degree da includes the plurality of computation results, the computation results may tend to be different from each other, or may tend to be similar to each other.

In a case where the computer 100 is made to function as the machine learning device 6 as described above, the machine learning device 6 outputs the computation result 30 to the display unit 100E.

### <Machine Learning Model 80>

The machine learning model 80 will next be described in detail. FIG. 40 is a diagram illustrating a configuration of the machine learning model 80. The machine learning model 80 is an inference model capable of learning using predetermined learning data. As illustrated in FIG. 40, the machine learning model 80 includes a three-layer neural network 50.

The three-layer neural network 50 is an AI model including an input layer 50A, a hidden layer 50B, and an output layer 50C. The hidden layer 50B is referred to also as a reservoir hidden layer or an intermediate layer. In addition, in the following, the input data din may be denoted by a symbol x. Similarly, the output data do may be denoted by a symbol y.

In general, in the three-layer neural network 50, for n-dimensional input data x∈R^{k×n} of a batch size k, an n′-dimensional inference result y∈R^{k×n′} is obtained as y=G (x·x+b)·β. G is an activation function of the hidden layer 50B. Sigmoid, reLU, or other functions, for example, can be used as the activation function. Incidentally, in FIG. 40, the batch size k is set at 1, and b is set to be a zero matrix.

Here, α∈R^{n×m} illustrated in FIG. 40 is a weight (first connection weight) connecting the input layer 50A and the hidden layer 50B to each other. β∈R^{m×n′} is a weight (third connection weight) connecting the hidden layer 50B and the output layer 50C to each other. b∈R^{k×m} is a bias. In addition, h∈R^{m} is a hidden layer matrix within the hidden layer 50B. γ∈R^{m×m} is a weight (second connection weight) connecting elements (h₁ to hₙ) within the hidden layer 50B to each other, and is a weight when a recursive calculation to be described later is performed.

The three-layer neural network 50 adopts an algorithm that can sequentially perform learning with an arbitrary batch size. In a case where ith learning data {xᵢ∈R^{ki×n}, tᵢ∈R^{ki×n′}} of a batch size kᵢ is obtained, βᵢ that minimizes an error illustrated in the following Equation (1) needs to be obtained.

$$\begin{matrix}[ Math . 8 ] & \\ ‖ [ \begin{matrix}{h}_{0} \\ ⋮ \\ {h}_{i}\end{matrix} ] {β}_{i} - [ \begin{matrix}{t}_{0} \\ ⋮ \\ {t}_{i}\end{matrix} ] ‖ & ( 1 )\end{matrix}$$

Incidentally, an ith hidden layer matrix hi is G(F). Details of the argument F will be described later. In addition, t is teacher data corresponding to an ith inference result (yi).

An optimized weight βᵢ is calculated by the following Equation (2). Incidentally, Pi is a matrix for updating the weight βᵢ.

$${P}_{i} = {P}_{i - 1} - {P}_{i - 1} {{h}_{i}^{T} ( I + {h}_{i} {P}_{i - 1} {h}_{i}^{T} )}^{- 1} {h}_{i} {P}_{i - 1} \qquad ( 2 )$$

$${β}_{i} = {β}_{i - 1} - {P}_{i} {h}_{i}^{T} ( {t}_{i} - {h}_{i} {β}_{i - 1} )$$

Here, P₀ and β₀ are obtained by the following Equation (3).

$${P}_{0} = {( {h}_{0}^{T} {h}_{0} )}^{- 1} \qquad ( 3 )$$

$${β}_{0} = {P}_{0} {h}_{0}^{T} {t}_{0}$$

The learning algorithm is as follows.

The values of the weight α, the weight γ, and the hidden layer matrix h are initialized by random numbers.

h₀ for x₀ is calculated, and P₀ and β₀ are calculated.

Pᵢ and βᵢ are sequentially calculated each time the ith learning data of the batch size kᵢ is obtained.

A bottleneck in terms of computational complexity in the foregoing Equation (2) is (I+hᵢPᵢ₋₁ hᵢ^{T})⁻¹. The matrix size of (I+hᵢPᵢ₋₁ hᵢ^{T}) is k×k. Therefore, in a case where k=1, inverse matrix computation can be replaced with reciprocal computation. Hence, the computation is facilitated even in a computing device such as a microcomputer by fixing the batch size at k=1. Therefore, in the machine learning model 80, the batch size is fixed at k=1.

In addition, the machine learning model 80 may perform learning using an autoencoder. The autoencoder uses input data as teacher data as it is, and performs learning so as to be able to reconstruct the input data as an inference result. That is, in the case of the above description, learning is performed with t=x. The autoencoder does not necessitate the generation of separate teacher data, and is therefore a kind of unsupervised learning algorithm. In addition, by making the number of nodes of the hidden layer smaller than the numbers of nodes of the input layer and the output layer, it is possible to regard the hidden layer matrix as an input data dimension compression type when an error between the input data and the inference result converges. That is, a result of encoding the input data x is h=G(F), and a result of decoding h is obtained as a hidden layer matrix y=h·B.

<Input Elements x₁ to xₙ of Input Data din>

As illustrated in FIG. 40, the input data din in this case is time series data, as described above. The input data din includes input elements x₁ to xₙ obtained by dividing the time series data into the individual elements. In addition, the output data do includes output elements y₁ to yᵢ. Output elements y₁ to y_{n′} are individual inference results for the input elements x₁ to xₙ as a result of the use of the machine learning model 80. In addition, in FIG. 40, the hidden layer matrix h of the hidden layer 50B when inference is performed by inputting the input elements x₁ to xₙ to the machine learning model 80 is set as hidden layer matrixes h₁ to hₘ.

Here, an amount of calculation becomes enormous if computation is performed by inputting all of the input elements x₁ to xₙ of the input data din to the machine learning model 80 at a time. Accordingly, the machine learning device 6 divides the input data din, that is, the input elements x₁ to xₙ into each unit of a predetermined number of elements when the input data din is input to the machine learning model 80. This divided set is referred to as a chunk. Then, the input elements x₁ to xₙ are input to the machine learning model 80 in each chunk, and computation by the machine learning model 80 is performed for each chunk. A more concrete description will be made as follows.

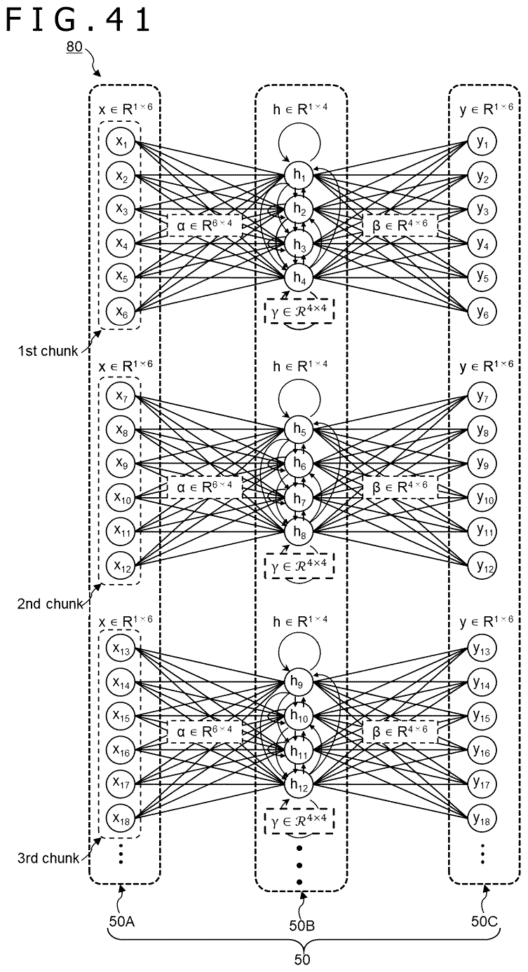

FIG. 41 is a diagram schematically illustrating a mode in which the input data din is divided into a plurality of chunks, which are input to the machine learning model 80 to be subjected to computation. In this case, as illustrated in FIG. 41, one chunk is divided by six elements. That is, a first chunk of the input data din includes input elements x₁ to x₆. A second chunk includes input elements x₇ to x₁₂. A third chunk includes input elements x₁₃ to x₁₈.

First, the first chunk of the input data din (=the input elements x₁ to x₆) is input to the machine learning model 80, and an inference result (output elements y₁ to y₆) is calculated. Next, the elements of the second chunk of the input data din (=the input elements x₇ to x₁₂) are input to the machine learning model 80, and an inference result (output elements y₇ to y₁₂) is calculated. Next, the elements of the third chunk of the input data din (=the input elements x₁₃ to x₁₈) are input to the machine learning model 80, and an inference result (output elements y₁₃ to y₁₈) is calculated. Elements of the input data din in each of a fourth and subsequent chunks (not illustrated) are similarly input to the machine learning model 80, and an inference result is calculated.

### <Details of Hidden Layer 50B>

The hidden layer 50B performs recursive calculation using the activation function G(F). The argument F of the activation function G uses a predetermined calculation equation determined so as to make elements (=the input elements x₁ to xₙ) act on each other. To “make the elements act on each other” in this case can be reworded as integrating characteristics (=information) of the elements as one piece of information.

The calculation equation of the argument F includes a first variable obtained by multiplying an element (x₁ to xₙ) of the input layer 50A by the weight α and a second variable obtained by multiplying a hidden layer matrix (h₁ to hₘ) of the hidden layer 50B by the weight γ. In the case of the calculation equation of F for an ith input element x₁, the first variable is xᵢ·α. In addition, in this case, the second variable is hᵢ₋₁·γ. An addition, an outer product, or a Hadamard product of the first variable and the second variable, for example, can be adopted as the argument F. A more detailed description is as follows.

In a case where the argument F is set as an addition of the first variable and the second variable, the argument F is the following Equation (4). k₁ and k₂ are predetermined weights, and are numerical values that can be set arbitrarily.

$$\begin{matrix}[ Math . 9 ] & \\ F = {k}_{1} {x}_{i} \cdot α + {k}_{2} {h}_{i} \cdot γ & ( 4 )\end{matrix}$$

In a case where the argument F is set as an outer product of the first variable and the second variable, the argument F is the following Equation (5).

$$\begin{matrix}[ Math . 10 ] & \\ F = ( {x}_{i} \cdot α ) \times ( {h}_{i} \cdot γ ) & ( 5 )\end{matrix}$$

In a case where the argument F is set as a Hadamard product of the first variable and the second variable, the argument F is the following Equation (6).

$$\begin{matrix}[ Math . 11 ] & \\ F = ( {x}_{i} \cdot α ) ⊙ ( {h}_{i} \cdot γ ) & ( 6 )\end{matrix}$$

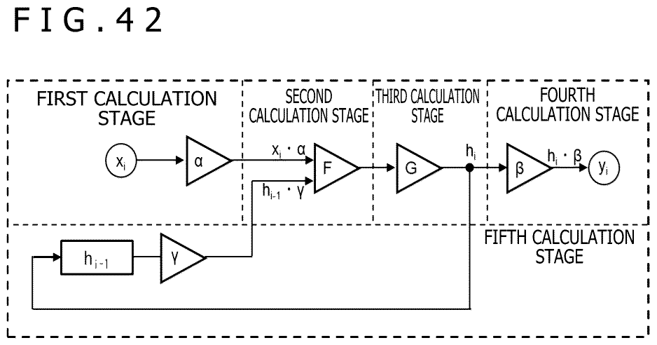

FIG. 42 is a diagram illustrating calculation stages at a time of inference using the input data din and the machine learning model 80. FIG. 42 illustrates calculation for the ith input element xᵢ among the input elements x₁ to xₙ. A state illustrated in FIG. 42 represents a mode in which computation for the input element xᵢ is performed in a state in which a computation result hᵢ₋₁·γ of the activation function G for an immediately preceding input element xᵢ₋₁ is already obtained.

As illustrated in FIG. 42, first, a calculation for the input element xᵢ is performed in a first calculation stage. In the first calculation stage, the weight α is made to act on the input element xᵢ. Specifically, xᵢ·α is obtained by multiplying the input element xᵢ and the weight α together.

Next, in a second calculation stage, the argument F is calculated on the basis of xᵢ·α obtained in the first calculation stage and the already obtained hᵢ₋₁·γ described above. hᵢ₋₁·γ can be said to include the information of the immediately preceding input element xᵢ₋₁ (more specifically, include the information of the input element xᵢ₋₁ and the information of input elements preceding the input element xᵢ₋₁). The calculation in this second calculation stage can therefore be construed as recursive calculation using the immediately preceding element (input element xᵢ₋₁ in this case) recursively for the calculation.

Next, in a third calculation stage, a computation result hᵢ is obtained by substituting the argument F into the activation function G. Next, in a fourth calculation stage, the hᵢ is multiplied by the weight β. An output element yᵢ is consequently generated.

Incidentally, after the computation result hᵢ is obtained in the third calculation stage, a calculation for hᵢ is performed in a fifth calculation stage separately from the fourth calculation stage. A concrete description is as follows.

In the fifth calculation stage, first, hᵢ is temporarily stored. Then, the stored hᵢ is multiplied by the weight γ in advance before an end of a calculation in the first stage for a next input element xᵢ₊₁. Incidentally, FIG. 42 illustrates a state in which a calculation for xᵢ is performed in the second calculation stage. FIG. 4 therefore illustrates a state in which hᵢ₋₁ is stored and is multiplied by the weight γ in the fifth calculation stage.

A calculation in the second calculation stage for the next input element xᵢ₊₁ is a calculation using xᵢ₊₁·α and hᵢ·γ. That is, hᵢ obtained in the third stage is made to return to the second calculation stage, and made to act on xᵢ₊₁. In other words, the calculation result obtained in the third calculation stage is made to return to the second calculation stage via the fifth calculation stage, and is made to act on the information of the next input element in the second calculation stage. The above-described recursive calculation through the second calculation stage, the third calculation stage, and the fifth calculation stage is performed within the hidden layer 50B (see FIG. 40 and FIG. 41).

This recursive calculation is repeated each time inference is sequentially performed for the input elements x₁ to xₙ. That is, each time a calculation is sequentially performed for the input elements x₁ to xₙ, the information of the input element (xᵢ) as a present computation target is included in the information of a past input element (xᵢ₋₁ in FIG. 42), and is accumulated as the hidden layer matrix hₘ.

Suppose that the calculation has been completed for all of the input elements within one chunk among the input elements x₁ to xₙ. The output elements y₁ to y_{n′} generated by the calculation within this chunk are temporarily stored. A location for the temporary storage at this time may be the data storage section 7, or may be a predetermined volatile memory. Then, the input elements x₁ to xₙ and the output elements y₁ to y_{n′} are reset from the machine learning model 80.

Then, while the hidden layer matrix hₘ is not reset, but is maintained as it is, input elements of a next chunk among the input elements x₁ to xₙ are input to the machine learning model 80. Incidentally, at this time, the random number of the weight α may be reset, or may be maintained as it is. Then, the output elements y₁ to y_{n′} corresponding to the chunks are generated through the calculation for the input elements x₁ to xₙ that are input.

### <Consideration Related to Amount of Input Data and Calculation Load>

The recursive calculation as described above is not performed in a machine learning model of an ordinary neural network (for example, a feedforward neural network thus far). Such a machine learning model can learn, detect, and distinguish characteristics of input elements within a same chunk in a case of performing learning/inference so as to straddle chunks. However, when the learning/inference is performed so as to straddle the chunks, it is not possible to learn, detect, or distinguish characteristics that are present so as to be common to input elements in different chunks. That is, the characteristics of the input data that are present so as to straddle chunks may not be effectively utilized for computation by the machine learning model.

In such a case, suppose that, for example, the number of input elements included within a chunk is made relatively large or all of the input elements are input to the machine learning model at a time. Then, it can also be said that the range of one chunk is extended. In other words, the number of chunks is decreased with respect to the input data din. Then, as compared with a large number of chunks, predetermined characteristics mutually possessed by input elements tend to be present within one chunk. There is thus a possibility of being able to solve the problem as described above. However, as described above, this causes the amount of calculation to be enormous, and increases a calculation load on the machine learning model.

On the other hand, the machine learning model 80 according to the present disclosure accumulates the sequentially calculated information of the input elements xᵢ to xₙ in the hidden layer matrix hₘ of the hidden layer 50B by the above-described recursive calculation. Further, as described above, when a chunk is changed, the hidden layer matrix hₘ is maintained without being reset. That is, there is a possibility of being able to learn, detect, and distinguish characteristics present in the input elements xᵢ to xₙ in different chunks without increasing the number of the input elements xᵢ to xₙ within the chunks. Hence, the characteristics of the input data din (input elements xᵢ to xₙ) that are present so as to straddle chunks can be effectively utilized for computation by the machine learning model 80 while an increase in the calculation load on the machine learning model 80 is suppressed.

In addition, as described above, the machine learning model 80 according to the present disclosure fixes the weight α and the weight γ, and does not update the weight α and the weight γ by learning and inference. It is therefore possible to suppress an increase in the calculation load of the machine learning model 80 more effectively.

### <Consideration Related to On-Device Learning>

Here, in general, the machine learning model can make an inference result more appropriate by taking enormous data into the machine learning model (making the machine learning model learn enormous data) at a time of learning. Therefore, in a case of a machine learning model from which a more accurate inference result is required, the machine learning model is, for example, incorporated into a PC having a high computing power, or the machine learning model is made to cooperate in the cloud with a high-performance computer such as a server computer.

On the other hand, the machine learning model 80 described above may be directly incorporated into a control circuit of a machine system (for example, an edge computer such as a microcomputer of a motor device) or other circuits so as to perform generally-called on-device learning. The on-device learning refers to learning on an AI chip (device) without cooperating with a cloud server.

In general, in a case where the machine learning model is made to perform the on-device learning, the machine learning model is incorporated in an edge computer (for example, a microcomputer that performs driving control of the motor device or other computers) as an end point of the machine system. Unlike a server computer, a high-performance PC, other computers, such a computer is subjected to limitation such as power consumption saving and space saving. That is, such a computer has a low computing power as compared with the server computer or other computers.

The data amount of the input data din for learning/inference in the machine learning model incorporated in the edge computer is therefore limited. That is, the machine learning model that performs the on-device learning is not suited to the learning/inference of enormous data as described above.

### <Usefulness of Machine Learning Model 80 According to Present Disclosure>

For such problems, the machine learning model 80 adopts methods such as the algorithm of (A) to (C), learning using the autoencoder, computation with the input data din divided into each chunk, and recursive calculation in the hidden layer 50B, as described above. These enable a certain accuracy of learning/inference or higher even when enormous data is not input to the machine learning model 80. The above-described recursive calculation in the hidden layer 50B in particular enables the machine learning model 80 to obtain information that is present so as to straddle chunks while the calculation load is reduced.

The machine learning model 80 is therefore more suitable when implemented for the on-device learning in the microcomputer of the machine system or other computers. In addition, without being limited to the on-device learning, also in a case where the machine learning model 80 is incorporated in a high-performance computer, the machine learning model 80 is effective in that the machine learning model 80 can reduce calculation cost and increase calculation resources.

<Abnormality Degree da>

The abnormality degree da will next be described in detail. As described above, the output data do is the data of an inference result obtained as a result of performing inference by inputting the input data din to the machine learning model 80. The input/output error is calculated by the loss function on the basis of the input data din and the output data do.

That is, the abnormality degree da as the input/output error represents an error between the input data din (=the input data din) and the inference result (output data do) based on the input data din. In other words, the abnormality degree da is an error between the actual input data din and inferred input data din in calculation (=the output data do). Hence, the abnormality degree da can be said to indicate an abnormality possessed by the input data din. The calculation of the abnormality degree da is specifically as follows.

MAE, MSE, or other functions, for example, can be adopted as the loss function for calculating the input/output error. In a case where the loss function is MAE, the loss function L is expressed as in the following Equation (7).

$$\begin{matrix}[ Math . 12 ] & \\ L ( {y}_{i} , {x}_{i} ) = \frac{1}{{n}^{′}} \sum \vert {y}_{i} - {x}_{i} \vert & ( 7 )\end{matrix}$$

In addition, in a case where the loss function is MSE, the loss function L is expressed as in the following Equation (8).

$$\begin{matrix}[ Math . 13 ] & \\ L ( {y}_{i} , {x}_{i} ) = \frac{1}{{n}^{′}} \sum {\vert {y}_{i} - {x}_{i} \vert}^{2} & ( 8 )\end{matrix}$$

When the abnormality degree da is calculated as described above, the user can determine whether or not an abnormal value is included in the input data din or, in turn, whether or not an abnormality has occurred in the machine system in which the machine learning device 6 is implemented or other devices.

### Modifications

Besides, the present disclosure is not limited to the foregoing embodiments, but is susceptible of various changes without departing from the spirit of the present disclosure. For example, in the example of abnormality detection for the machine system described above, learning is performed immediately before inference. However, the learning may not be performed immediately before the inference, but an already learned machine learning model 80 may be used. In addition, the argument F is not limited to the foregoing Equations (4) to (6).

### SUPPLEMENTARY NOTES

A machine learning device (6) disclosed in the specification includes a machine learning model (80) having an input layer (50A), an output layer (50C), and a hidden layer (50B) that is disposed between the input layer (50A) and the output layer (50C) and internally performs recursive calculation, a model retaining section (8) configured to retain the machine learning model (80), a data storage section (7) configured to store input data (din) that is input to the machine learning model (80), and a computing section (9) configured to perform calculation of learning or inference by inputting the input data (din) to the machine learning model (80), a first connection weight (α) between the input layer (50A) and the hidden layer (50B) and a second connection weight (γ) within the hidden layer (50B) being set to a fixed set value or a random number that is not updated by the learning, and a third connection weight (B) between the hidden layer (50B) and the output layer (50C) being set to be updated by the learning (first configuration).

The machine learning device (6) according to the first configuration is preferably configured such that the computing section (9) sequentially calculates the third connection weight βi as a parameter of the machine learning model (80) by (A) Equation below (second using configuration).

$${P}_{i} = {P}_{i - 1} - {P}_{i - 1} {{h}_{i}^{T} ( I + {h}_{i} {P}_{i - 1} {h}_{i}^{T} )}^{- 1} {h}_{i} {P}_{i - 1} \qquad ( A )$$

$${β}_{i} = {β}_{i - 1} + {P}_{i} {h}_{i}^{T} ( {t}_{i} - {h}_{i} {β}_{i - 1} )$$

where a hidden layer (50B) matrix hᵢ is G(F), Pᵢ is a matrix for updating the third connection weight βᵢ, G is an activation function of the hidden layer (50B), xᵢ is ith input data (din) of a batch size kᵢ, and tᵢ is ith teacher data of the batch size kᵢ.

The machine learning device (6) according to the second configuration is preferably configured such that the computing section (9) calculates the third connection weight β₀ as a parameter by using (B) Equation below (third configuration).

$${P}_{0} = {( {h}_{0}^{T} {h}_{0} )}^{- 1} \qquad ( B )$$

$${β}_{0} = {P}_{0} {h}_{0}^{T} {t}_{0}$$

The machine learning device (6) according to the second configuration is preferably configured such that an argument F of the activation function G is calculated by a calculation equation including a first variable obtained by multiplying the first connection weight α and the input data (din) xᵢ together and a second variable obtained by multiplying the second connection weight γ and the hidden layer matrix hᵢ₋₁ together (fourth configuration).

The machine learning device (6) according to the second configuration is preferably configured such that the argument F is calculated by using (C) Equation below (fifth configuration).

$$F = {k}_{1} {x}_{i} \cdot α + {k}_{2} {h}_{i - 1} \cdot γ \qquad ( C )$$

where k₁ and k₂ are predetermined constants.

The machine learning device (6) according to the second configuration is preferably configured such that the argument F is calculated by using (D) Equation below (sixth configuration).

$$F = ( {x}_{i} \cdot α ) \times ( {h}_{i - 1} \cdot γ ) \qquad ( D )$$

where x is an outer product symbol

The machine learning device (6) according to the second configuration is preferably configured such that the argument F is calculated by using (E) Equation below (seventh configuration).

$$F = ( {x}_{i} \cdot α ) ∘ ( {h}_{i - 1} \cdot γ ) \qquad ( E )$$

where ∘ is a Hadamard product symbol.

A semiconductor apparatus (100) disclosed in the specification includes the machine learning device (6) according to one of the first to seventh configurations in an integrated state (eighth configuration).

The semiconductor apparatus (100) according to the eighth configuration is a microcontroller including: a storage section (100B, 100C) including the model retaining section (8) and the data storage section (7) and configured to be capable of storing predetermined information; and a processor (100A) including the computing section (9), and configured to perform computation on a basis of the information stored in the storage section (100B, 100C) (ninth configuration).

A simulation program (P) disclosed in the specification is a simulation program for being made to function as the machine learning device (6) according to one of the first to seventh configurations (tenth configuration).

A simulation device (100) disclosed in the specification obtains an inference result based on the input data (din) by using the machine learning device (6) according to one of the first to seventh configurations (eleventh configuration).

The present disclosure contains subject matter related to that disclosed in Japanese Priority Patent Application 2025-6752 filed in the Japan Patent Office on Jan. 17, 2025, 2025-6189 on Jan. 16, 2025, 2025-13776 on Jan. 30, 2025 and 2025-201828 on Nov. 21, 2025, the entire contents of which are hereby incorporated by reference.

What is claimed is:

1. An abnormality detecting method using a computing device,
one cluster of data in a case where data is sequentially supplied to a machine learning model being referred to as a chunk,
the abnormality detecting method comprising:
obtaining a learning result by performing unsupervised learning by the machine learning model with a predetermined chunk width on a basis of first data;
obtaining an inference result by performing inference by the machine learning model with the chunk width on a basis of second data and the learning result; and
calculating an interval abnormality degree for each interval obtained by dividing the chunk width into a plurality of intervals on a basis of the second data and the inference result.

2. The abnormality detecting method according to claim 1, comprising:
calculating an abnormality degree for each chunk width on the basis of the second data and the inference result.

3. The abnormality detecting method according to claim 1, comprising:
calculating the interval abnormality degree for each interval in a state in which the plurality of intervals are shifted by a set shift amount.

4. The abnormality detecting method according to claim 1, wherein
the first data and the second data are data after frequency analysis processing.

5. A computing device used for the abnormality detecting method according to claim 1.

6. A program used for the abnormality detecting method according to claim 1.

7. A correcting method for correcting abnormal data detected by the abnormality detecting method according to claim 1.

8. An abnormality degree generating device comprising:
one cluster of data in a case where data is sequentially supplied to a machine learning model being referred to as a chunk,
a learning processing section that obtains a learning result by performing unsupervised learning by the machine learning model with a predetermined chunk width on a basis of first data;
an inference processing section that obtains an inference result by performing inference by the machine learning model with the chunk width on a basis of second data and the learning result; and
an interval abnormality degree calculating section that calculates an interval abnormality degree for each interval obtained by dividing the chunk width into a plurality of intervals on a basis of the second data and the inference result.

9. The abnormality degree generating device according to claim 8, wherein
the first data and the second data are temporal change data of a measurement target, and
the abnormality degree generating device includes a correcting section that corrects data in an interval in which an abnormality is detected on a basis of the interval abnormality degree.

10. The abnormality degree generating device according to claim 9, wherein
the abnormality degree generating device is a biochemical analysis device, and
the temporal change data of the measurement target is absorbance data of a test liquid.

11. A machine learning device comprising:
a model retaining section that retains a first machine learning model;
a first data processing section that generates first sampling data by being directly supplied with target data and sampling the target data, and converts the first sampling data into a first frequency amplitude spectrum; and
a first computing section that performs at least one of learning and inference by inputting the first frequency amplitude spectrum to the first machine learning model, and calculates a first computation result.

12. The machine learning device according to claim 11, wherein
the first data processing section samples the target data at two or more kinds of sampling frequencies.

13. The machine learning device according to claim 12, wherein
the two or more kinds of sampling frequencies are each relatively prime.

14. The machine learning device according to claim 11, further comprising:
a second data processing section and a second computing section, wherein
the model retaining section retains also a second machine learning model,
the second data processing section generates second sampling data by sampling the target data via an antialiasing filter, and converts the second sampling data into a second frequency amplitude spectrum, and the second computing section performs at least one of learning and inference by inputting the second frequency amplitude spectrum to the second machine learning model, and calculates a second computation result.

15. An electronic apparatus comprising:
a machine learning device according to claim 11.

16. A program for a computer, comprising:
a first step of generating first sampling data by being directly supplied with target data and sampling the target data, and converting the first sampling data into a first frequency amplitude spectrum; and
a second step of performing at least one of learning and inference by inputting the first frequency amplitude spectrum to a first machine learning model, and calculating a first computation result.

17. A simulation device, wherein
the simulation device calculates a first computation result by using the machine learning device according to claim 11.

18. A data processing method comprising:
a first step of generating first sampling data by being directly supplied with target data and sampling the target data, and converting the first sampling data into a first frequency amplitude spectrum; and
a second step of performing at least one of learning and inference by inputting the first frequency amplitude spectrum to a first machine learning model, and calculating a first computation result.

19. A machine learning device comprising:
a machine learning model having an input layer, an output layer, and a hidden layer that is disposed between the input layer and the output layer and internally performs recursive calculation;
a model retaining section that retains the machine learning model;
a data storage section that stores input data that is input to the machine learning model; and
a computing section that performs calculation of learning or inference by inputting the input data to the machine learning model,
a first connection weight between the input layer and the hidden layer and a second connection weight within the hidden layer being set to a fixed set value or a random number that is not updated by the learning, and
a third connection weight between the hidden layer and the output layer being set to be updated by the learning.

20. The machine learning device according to claim 19, wherein
the computing section sequentially calculates the third connection weight βi as a parameter of the machine learning model by using (A) Equation below,
$$Pi = Pi - 1 - Pi - 1 hiT ( I + hiPi - 1 hiT ) - 1 hiPi - 1 \qquad ( A )$$
$$β i = β i - 1 + PihiT ( ti - hi β i - 1 )$$
where a hidden layer matrix hi is G(F), Pi is a matrix for updating the third connection weight βi, G is an activation function of the hidden layer, xi is ith input data of a batch size ki, and ti is ith teacher data of the batch size ki.

21. The machine learning device according to claim 20, wherein
the computing section calculates the third connection weight β0 as the parameter by using (B) Equation below,
$$P 0 = ( h 0 Th 0 ) - 1 \qquad ( B )$$
$$β0 = P 0 h 0 Tt 0$$

22. The machine learning device according to claim 20, wherein
the argument F of the activation function G is calculated by a calculation equation including
a first variable obtained by multiplying the first connection weight α and the input data xi together, and a second variable obtained by multiplying the second connection weight γ and the hidden layer matrix hi−1 together.

23. The machine learning device according to claim 20, wherein
the argument F is calculated by using (C) Equation below,
$$F = k 1 xi \cdot α + k 2 hi - 1 \cdot γ \qquad ( C )$$
where k1 and k2 are predetermined constants.

24. The machine learning device according to claim 20, wherein
the argument F is calculated by using (D) Equation below,
$$F = ( xi \cdot α ) \times ( hi - 1 \cdot γ ) \qquad ( D )$$
where x is an outer product symbol.

25. The machine learning device according to claim 20, wherein
the argument F is calculated by using (E) Equation below,
$$F = ( xi \cdot α ) ∘ ( hi - 1 \cdot γ ) \qquad ( E )$$
where ∘ is a Hadamard product symbol.

26. A semiconductor apparatus comprising:
a machine learning device according to claim 19 in an integrated state.

27. A microcontroller as the semiconductor apparatus according to claim 26, the microcontroller comprising:
a storage section that includes the model retaining section and the data storage section and be capable of storing predetermined information; and
a processor that includes the computing section and performs computation on a basis of the information stored in the storage section.

28. A machine learning program made to function as the machine learning device according to claim 19.

29. A simulation device for obtaining an inference result based on the input data by using the machine learning device according to claim 19.
